(19) United States
(12) Patent Application Publication
(10) Pub. No.: US 2010/0138896 A1
(43) Pub. Date: Jun. 3, 2010

(54) INFORMATION PROCESSING SYSTEM AND INFORMATION PROCESSING METHOD

(76) Inventor: Atsushi Honda, Tokyo (JP)

Correspondence Address: Mr. Jackson Chen, 6535 N. STATE HWY 161, IRVING, TX, 75039, US

(21) Appl. No.: 12/594,697

(22) PCT Filed: Apr. 3, 2008
(86) PCT No.: PCT/JP2008/056713

§ 371 Date: Dec. 7, 2009

(30) Foreign Application Priority Data
Apr. 5, 2007 (JP) 2007-099421

(51) Int. Cl. G06F 21/22; G06F 9/50

(52) U.S. Cl. 726/1; 718/104

(57) ABSTRACT

In an information processing system, when an application is added to an information processing apparatus, an identifier of an resource of the information processing apparatus which is used by the application is acquired, and a rule suitable for the application is generated based on a rule defined in advance in correspondence to the resource identifier. The generated rule is applied to the information processing apparatus.

### TECHNICAL FIELD

The present invention relates to an information processing system, an information processing method, and an information processing program that, upon addition of an application to a secure OS, generate an access control attribute of the application. It should be noted that this application claims a priority based on Japanese Patent Application No. 2007-099421, and the disclosure thereof is incorporated herein by reference.

### BACKGROUND ART

In recent years, in order to ensure security of an information processing apparatus, a secure OS such as SELinux capable of setting an access control attribute for each process has been developed. The access control attribute is an attribute used to determine an access control to a resource and an instruction executed by a corresponding process according to an access control rule.

However, such a secure OS has a problem that a task to generate the access control attribute is complicated and difficult. For the access control attribute, it is necessary to be very familiar with characteristics such as operations and behaviors of an application to be allocated with the access control attribute, and a configuration of a secure OS terminal on which the application is executed. For this reason, it is difficult for one who is not familiar with the configuration of the target terminal to generate the access control attribute of the application to be added.

One example of a system that solves such a problem will be described in Japanese Patent Application Publication (JP-P2005-234864A). This system includes a distribution server that stores security policies respectively describing access control rules for applications; and a secure OS terminal. Upon generation of an access control attribute, the secure OS terminal transmits data on an application to the distribution server to request a corresponding security policy. In response to the request from the secure OS terminal, the distribution server distributes the appropriate security policy to the secure OS terminal. The secure OS terminal generates the access control attribute for the application according to the security policy received from the distribution server. Based on this, the generation of the security policy describing an access control rule to be set for each application can be entrusted to an external organization, and an application creator who is very familiar with operations and behaviors of the application can generate the security policy. This allows the access control attribute to be generated by acquiring the corresponding security policy from the distribution server upon addition of the application to the secure OS terminal.

A first problem of the system described in Japanese Patent Application Publication (JP-P2005-234864A) is that when the application creator generates an access control rule to set an access control attribute for an application to be added, he/she should generate a plurality of access control rules. According to this technique, the reason is because the access control rule is differently configured depending on a configuration of the secure OS terminal, and therefore the plurality of access control rules should be generated for respective terminals having different configurations.

A second problem of the system described in Japanese Patent Application Publication (JP-P2005-234864A) is that when the application creator generates an access control rule, he/she should know the access control rule for the resource every time a resource available to the application is added to the secure OS terminal. According to the technique, the reason is because an access control rule is differently configured depending on a configuration of the secure OS terminal, and therefore a security policy should be generated on the basis of an access control rule in the terminal of which the configuration is changed by the addition of the resource.

### DISCLOSURE OF INVENTION

An object of the present invention is to facilitate the generation of an access control attribute of a secure OS for an added application.

Another object of the present invention is to allow an application creator to generate an access control attribute even if he/she does not know a configuration of a secure OS.

Still another object of the present invention is to allow an application creator to generate an access control attribute without generating an access control rule.

An information processing system of the present invention acquires identifiers of resources of the information processing apparatus to be used by an application upon addition of the application to the information processing apparatus; generates a rule appropriate for the application on the basis of a rule defined in advance in correspondence to the resource identifier; and applies the generated rule to the information processing apparatus.

Also, the information processing system of the present invention includes an additional application storage section that stores an application and identifiers of resources used by the application as a set; a secure OS that retains identifiers of resources to be accessed by the application; an access control rule storage section that stores the resource identifiers, and access control rules for the application to use the resources corresponding to the resource identifiers as a set; an application identifier storage section that stores identifiers allocated to the application; an application adding section that acquires the set of the application to be added and identifiers of the resources used by the application from the additional application storage section upon addition of the application to the information processing apparatus including the secure OS, refers to the application identifier storage section to allocate the application identifier to the application to be added, and transmits the set of acquired resource identifiers and the allocated application identifier, and an access control attribute generating section that acquires access control rules corresponding to the resource identifiers received from the application adding section, generates access control attribute for the application allocated with the application identifier on the basis of the acquired access control rules, and applies the generated access control attribute to the secure OS.

Such a configuration is employed, and the application adding section acquires the application and the resource identifiers of the resources used by the application from the additional application storage section, refers to the application identifier storage section to allocate the application identifier to the acquired application, and transmits the allocated application identifier and the acquired resource identifiers to the access control attribute generating section. The access control attribute generating section refers to the access control attribute storage section to acquire an access control rule forming a set with the received resource identifiers, generates an access control attribute for the application having the received application identifier on the basis of the acquired access control rules, and applies the generated access control attribute to the secure OS.

Also, the information processing system of the present invention includes: an additional application storage section that stores an application and identifiers of resources used by the application as a set; an update access control rule storage section that stores identifiers of resources for which an access control rule is to be updated, and the access control rule as a set; a secure OS that retains the identifiers of the resources to be accessed by the application, an access control rule storage section that stores the resource identifiers, and access control rules for the application to use the resources corresponding to the resource identifiers; an application identifier storage section that stores an identifier allocated to the application; an application data storage section that stores a set of the application identifier, and the identifiers of the resources used by the application corresponding to the application identifier; an application adding section that, upon addition of the application to the information processing apparatus including the secure OS, acquires the set of the application to be added, and the identifiers of the resources used by the application from the additional application storage section, refers to the application identifier storage section to allocate the application identifier to the application to be added, and transmits the set of acquired resource identifiers and the allocated application identifier; an access control attribute generating section that acquires access control rules corresponding to the resource identifiers received from the application adding section, generates an access control attribute for the application allocated with the application identifier on the basis of the acquired access control rules, applies the generated access control attribute to the secure OS, and stores the resource identifiers and application identifiers received from the application adding section in the application data storage section as application data; an access control rule updating section that acquires an access control rule corresponding to an identifier of the resource from the update access control rule storage section upon update of an access control rule of a resource, changes an access control rule stored in the access control rule storage section along with the identifier of the resource for which the access control rule is to be updated as a set to the access control rule acquired from the update access control rule storage section, and transmits the identifier of the resource for which the access control rule is updated; and an access control attribute regenerating section that acquires from the application data storage section, the application data including the resource identifier received from the access control rule updating section, acquires the access control rules corresponding to the resource identifiers included in the acquired application data, generates on the basis of the acquired access control rules, an access control attribute for the application identified by the application identifier included in the acquired application data, and applies the generated access control attribute to the secure OS.

### BRIEF DESCRIPTION OF DRAWINGS

FIG. 1 is a block diagram illustrating a configuration of an information processing system according to a first exemplary embodiment of the present invention;

FIG. 2 is a diagram illustrating data stored in a storage apparatus and an external storage apparatus in the information processing system in FIG. 1;

FIG. 3 is a flowchart illustrating an operation of an application adding section in the information processing system of FIG. 1;

FIG. 4 is a flowchart illustrating an operation of an access control attribute generating section in the information processing system of FIG. 1;

FIG. 5 is a flowchart illustrating an operation of a resource adding section in the information processing system of FIG. 1;

FIG. 6 is a block diagram illustrating a configuration of an information processing system according to a second exemplary embodiment of the present invention;

FIG. 7 is a diagram illustrating data stored in a storage apparatus and an external storage apparatus in the information processing system in FIG. 6;

FIG. 8 is a flowchart illustrating an operation of an access control attribute generating section in the information processing system of FIG. 6;

FIG. 9 is a flowchart illustrating an operation of an access control rule updating section in the information processing system of FIG. 6;

FIG. 10 is a flowchart illustrating an operation of an access control attribute regenerating section in the information processing system of FIG. 6;

FIG. 11 is a block diagram illustrating a configuration of an information processing system according to a third exemplary embodiment of the present invention;

FIG. 12 is a diagram illustrating data stored in a storage apparatus and an external storage apparatus in the information processing system in FIG. 11;

FIG. 13 is a flowchart illustrating an operation of an application adding section in the information processing system of FIG. 11;

FIG. 14 is a flowchart illustrating an operation of a resource restriction determining section in the information processing system of FIG. 11;

FIG. 15 is a flowchart illustrating an operation of a resource adding section in the information processing system of FIG. 11;

FIG. 16 is a block diagram illustrating a configuration of an information processing system according to a fourth exemplary embodiment of the present invention;

FIG. 17 is a diagram illustrating data stored in computers of the information processing system in FIG. 16;

FIG. 18 is a diagram illustrating an example of access control rules in the fourth exemplary embodiment of the present invention;

FIG. 19 is a block diagram illustrating a configuration of an information processing system according to a fifth exemplary embodiment of the present invention;

FIG. 20 is a diagram illustrating data stored in computers of the information processing system in FIG. 19;

FIG. 21 is a diagram illustrating an example of access control rules in the fifth exemplary embodiment of the present invention;

FIG. 22 is a block diagram illustrating a configuration of an information processing system according to a sixth exemplary embodiment of the present invention;

FIG. 23 is a diagram illustrating data stored in a computer of the information processing system in FIG. 22;

FIG. 24 is a diagram illustrating data stored in a computer of the information processing system in FIG. 22; and

FIG. 25 is a diagram illustrating an example of access control rules in the sixth exemplary embodiment of the present invention.

### BEST MODE FOR CARRYING OUT THE INVENTION

Hereinafter, an information processing system according to exemplary embodiments of the present invention will be described in detail with reference to the attached drawings.

### First Exemplary Embodiment

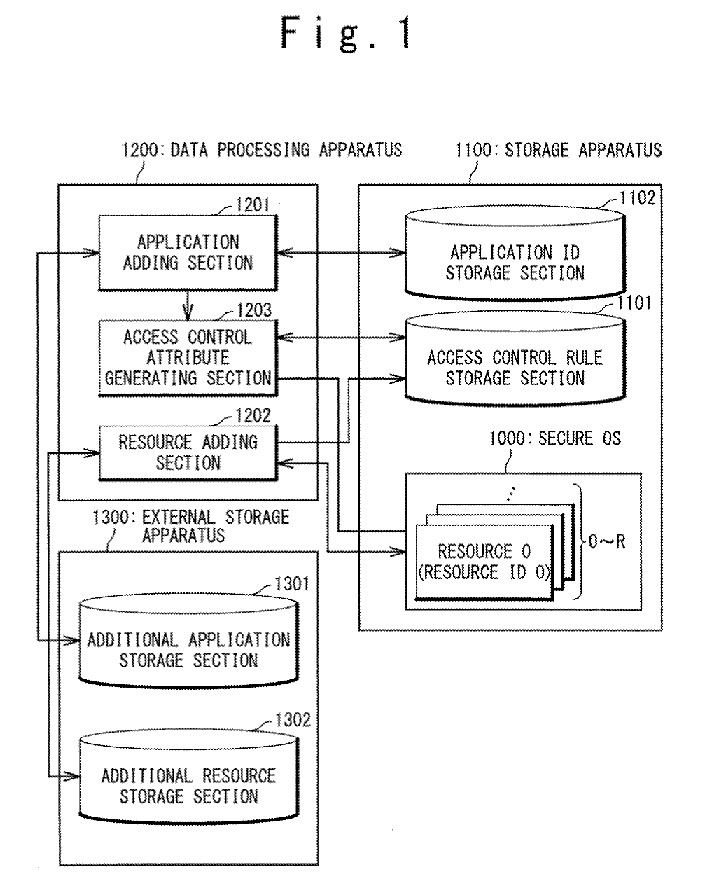

Referring to FIG. 1, an information processing system according to a first exemplary embodiment of the present invention includes a storage apparatus 1100; an external storage apparatus 1300; and a data processing apparatus 1200 that operates on the basis of a program control. The storage apparatus 100 includes an access control rule storage section 1101, and an application identifier (ID) storage section 1102. Further, the storage apparatus 1100 stores a secure OS 1000 that is processed by the data processing apparatus 1200. The data processing apparatus 1200 includes an application adding section 1201, a resource adding section 1202, and an access control attribute generating section 1203. The external storage apparatus 1300 includes an additional application storage section 1301, and an additional resource storage section 1302. The external storage apparatus 1300 is an apparatus accessible from the application adding section 1201 and the resource adding section 1202. As the external storage apparatus 1300, there is an external storage medium such as an SD (Secure Digital) card, and a storage apparatus inside an information processing terminal connected via a network.

The secure OS 1000 stores resource identifiers 0 to R (R is an integer equal to or more than 0) that are identifiers of resources 0 to R available to an application. It should be noted that the resources 0 to R are targets to be accessed by the application and to be managed by the secure OS 1000. Also, the secure OS 1000 has a function of transmitting a resource identifier Rₓ to the resource adding section 1202, when a resource Rₓ (Rₓ is an integer not less than 0 and not more than R) having the resource identifier Rₓ is added.

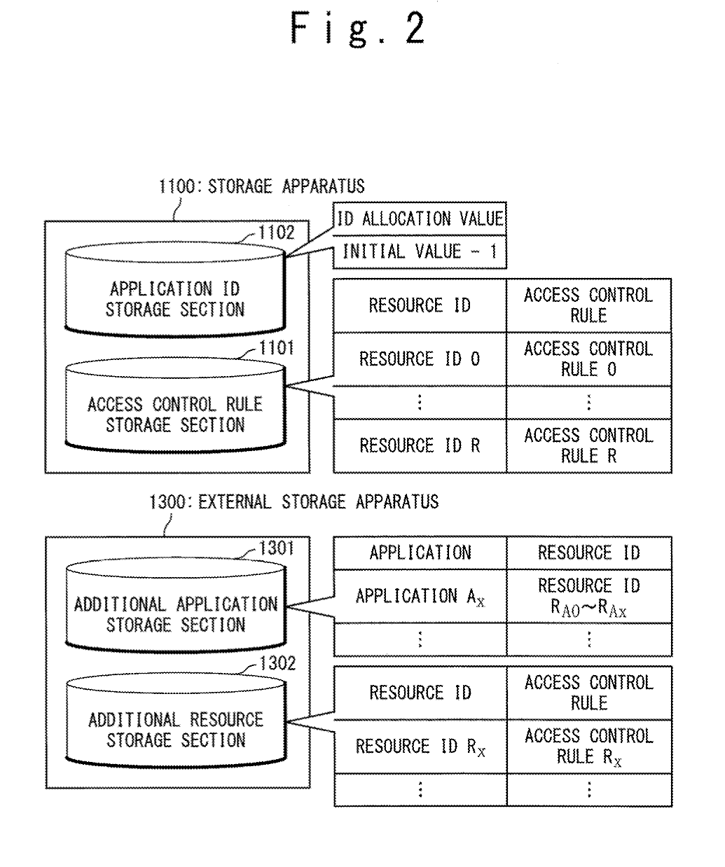

Referring to FIG. 2, the access control rule storage section 1101 stores sets of the resource identifiers 0 to R, and access control rules 0 to R for the application to use the resources 0 to R in advance. The access control rules are operations for the resources 0 to R, which are allowed for applications 0 to A (A is an integer equal to or more than 0) operating on the data processing apparatus 1200. The operations are ones controllable by the secure OS 1000. The access control rules may be resource usage limit rules that describe limits of usages or occupancy rates of the resources 0 to R used by the applications 0 to A. The resources include devices and objects. The application identifier storage section 1102 stores an identifier to be assigned to an application. The application identifier storage section 1102 stores −1 in advance as an initial value of the identifier.

The additional application storage section 1301 stores in advance an application Aₓ (Aₓ is an integer not less than 0 and not more than A) executable by the data processing apparatus 1200, and resource identifier R_{A0} to R_{Ax} (R_{A0} and R_{Ax} are integers not less than 0 and not more than R, and R_{A0}≦R_{Ax}) of all resources R_{A0} to R_{Ax} used by the application Aₓ.

The additional resource storage section 1302 stores a set of an access control rule Rₓ for the resource Rₓ, which can be added to the secure OS 1000, and the resource identifier Rₓ of the resource Rₓ. It is assumed that the additional resource storage section 1302 recognizes the resource identifier Rₓ assigned to the resource Rₓ by the secure OS 1000 in advance.

The application adding section 1201 has a function of acquiring the application Aₓ to be executed by the data processing apparatus 1200, and the resource identifiers R_{A0} to R_{Ax} of all of the resources R_{A0} to R_{Ax} used by the application Aₓ from the additional application storage section 1301; a function of referring to the application identifier storage section 1102 to assign an application identifier Aₓ to the application Aₓ; and a function of transmitting the assigned application identifier Aₓ, and the resource identifiers R_{A0} to R_{Ax} of all of the resources R_{A0} to R_{Ax} used by the application Aₓ to the access control attribute generating section 1203.

The resource adding section 1202 has a function of, upon addition of the resource Rₓ to the secure OS 1000, receiving the resource identifier Rₓ to acquire the access control rule Rₓ for the resource Rₓ from the additional resource storage section 1302, and storing the access control rule Rₓ along with the resource identifier Rₓ in the access control rule storage section 1101.

The access control attribute generating section 1203 has a function of receiving the resource identifiers R_{A0} to R_{Ax} and the application identifier Aₓ transmitted from the application adding section 1201; acquiring the access control rules R_{A0} to R_{Ax} corresponding to the resource identifiers R_{A0} to R_{Ax} from the access control rule storage section 1101; generating an access control attribute Aₓ for the application Aₓ having the application identifier Aₓ; and applying the access control attribute Aₓ to the secure OS 1000.

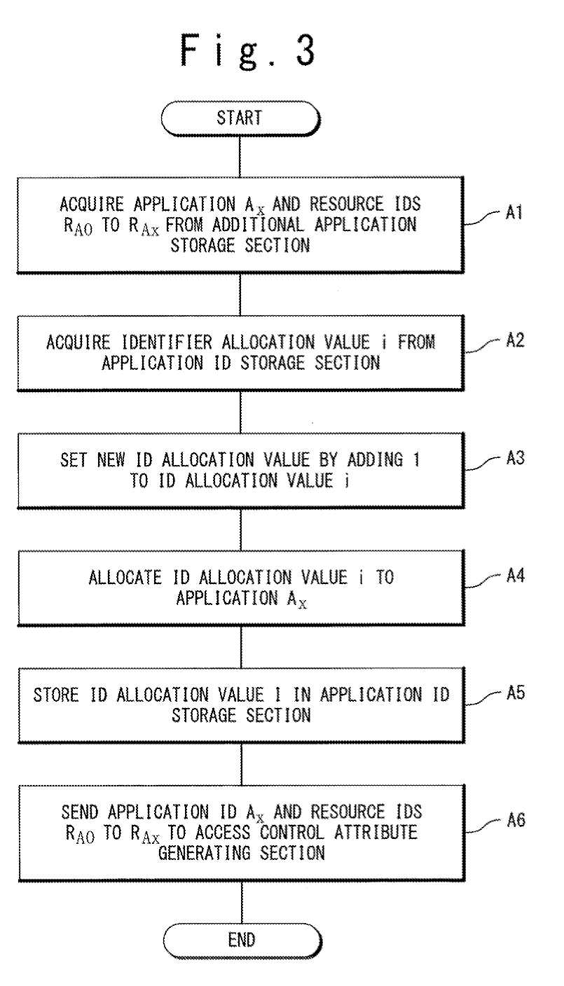

Next, referring to flowcharts of FIGS. 3 to 5, an operation of the information processing system in the first exemplary embodiment will be described in detail.

First, an operation of adding the application Aₓ will be described. The application adding section 1201 acquires the application Aₓ and the resource identifiers R_{A0} to R_{Ax} of all of the resources R_{A0} to R_{Ax} used by the application Aₓ from the additional application storage section 1301 of the external storage apparatus 1300 (Step A1 in FIG. 3). Then, the application adding section 1201 refers to the application identifier storage section 1102 to acquire an identifier allocation value i (i is an integer not less than −1 and not more than A) (Step A2). The application adding section 1201 sets a value obtained by adding 1 to the acquired identifier allocation value i to a new identifier allocation value i (Step A3), and allocates the new identifier allocation value i to the application Aₓ acquired from the additional application storage section 1301 as the application identifier Aₓ (Step A4). The application adding section 1201 stores the identifier allocation value i in the application identifier storage section 1102 (Step A5), and transmits the application identifier Aₓ and the resource identifiers R_{A0} to R_{Ax} to the access control attribute generating section 1203 (Step A6).

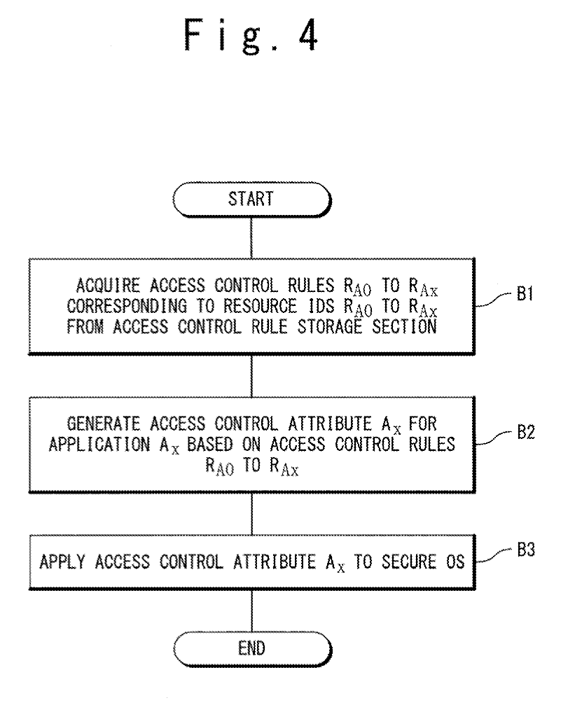

Subsequently, the access control attribute generating section 1203 acquires the access control rules R_{A0} to R_{Ax} corresponding to the received resource identifiers R_{A0} to R_{Ax} from the access control rule storage section 1101 (Step B1 in FIG. 4). The access control attribute generating section 1203 generates the access control attribute Aₓ for the application Aₓ having the application identifier Aₓ on the basis of the acquired access control rules R_{A0} to R_{Ax} (Step B2). The access control attribute generating section 1203 applies the generated access control attribute Aₓ to the secure OS 1000 (Step B3).

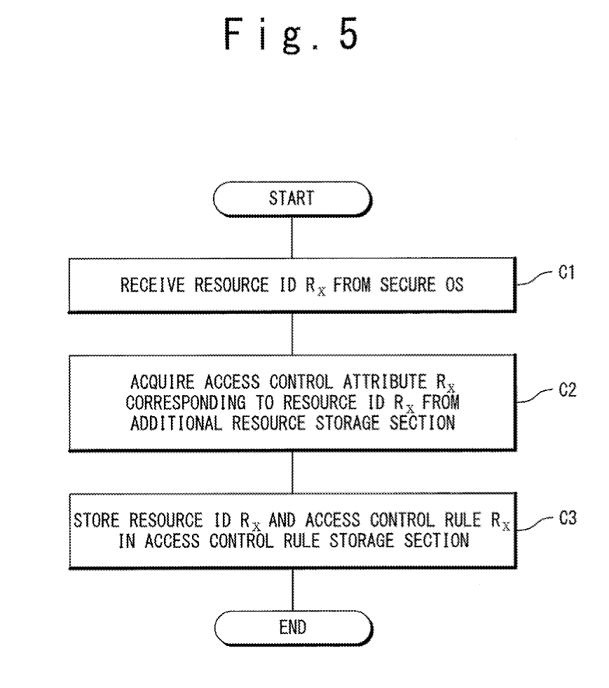

Next, an operation of adding the resource Rₓ will be described. When the resource Rₓ is added, the resource adding section 1202 receives the resource identifier Rₓ from the secure OS 1000 (Step C1 in FIG. 5). The resource adding section 1202 acquires the access control rule Rₓ corresponding to the resource identifier Rₓ from the additional resource storage section 1302 of the external storage apparatus 1300 (Step C2). The resource adding section 1202 stores a set of the resource identifier Rₓ and the access control rule Rₓ in the access control rule storage section 1101 (Step C3).

In the present exemplary embodiment, the objects of the present invention can be achieved by storing in advance the resource identifiers 0 to R of the resources managed by the secure OS 1000, and the access control rules 0 to R for an application to use the resources 0 to R as sets; upon addition of the application Aₓ to the secure OS 100, acquiring the resource identifiers R_{A0} to R_{Ax} of the resources used by the application Aₓ; on the basis of the access control rules R_{A0} to R_{Ax} corresponding to the acquired resource identifiers R_{A0} to R_{Ax} generating the access control attribute Aₓ for the added application Aₓ; and further, upon addition of the resource Rₓ to the secure OS 1000, simultaneously adding the access control rule Rₓ for the resource Rₓ.

### Second Exemplary Embodiment

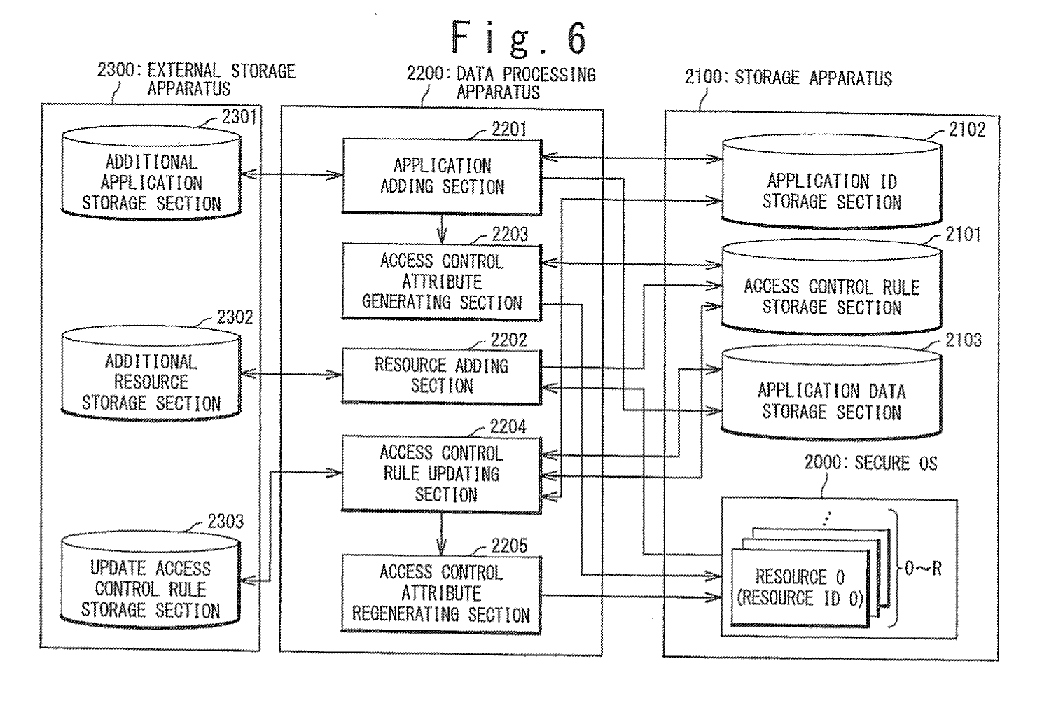

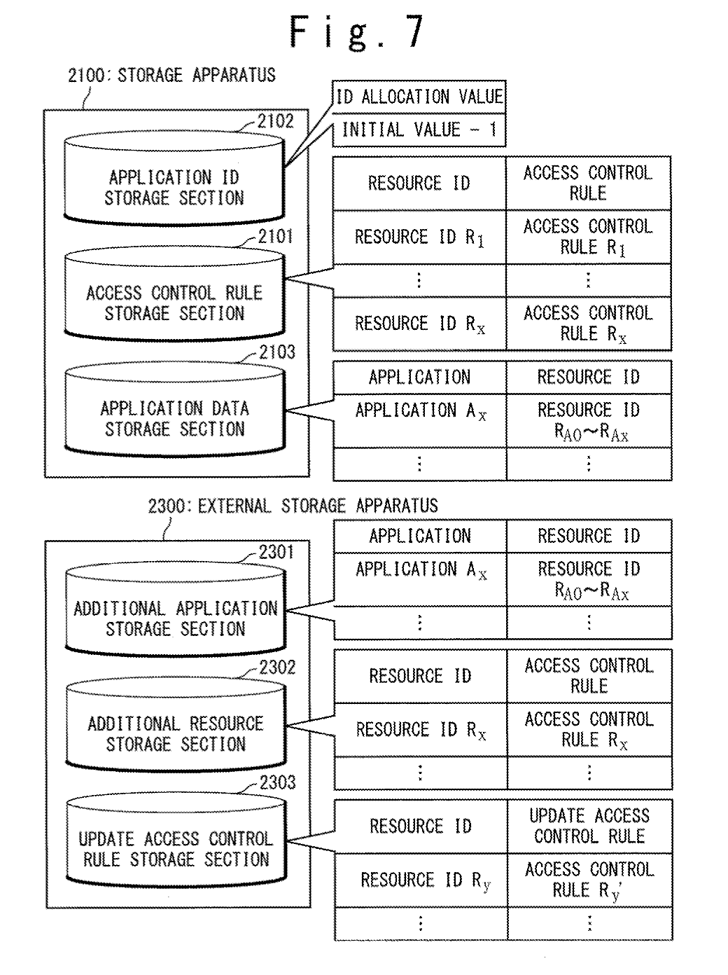

Next, the information processing system according to a second exemplary embodiment of the present invention will be described in detail referring to FIGS. 6 and 7. Referring to FIG. 6, the information processing system in the second exemplary embodiment of the present invention includes a storage apparatus 2100, an external storage apparatus 2300, and a data processing apparatus 2200 that operates on the basis of a program control. The storage apparatus 2100 includes an access control rule storage section 2101, an application identifier storage section 2102, and an application data storage section 2103. Further, the storage apparatus 2100 stores a secure OS 2000 that is processed by the data processing apparatus 2200. The secure OS 2000 includes functions equivalent to those of the secure OS 1000 in the first exemplary embodiment.

The data processing apparatus 2200 includes an application adding section 2201, the resource adding section 2202, an access control attribute generating section 2203, an access control rule updating section 2204, and an access control attribute regenerating section 2205.

The external storage apparatus 2300 includes an additional application storage section 2301, an additional resource storage section 2302, and an update access control rule storage section 2303. The external storage apparatus 2300 is an apparatus accessible from the application adding section 2201, the resource adding section 2202, and the access control rule updating section 2204. As an example of the external storage apparatus 2300, there is an external storage medium such as an SD card, and a storage apparatus inside an information processing terminal connected via a network.

The access control rule storage section 2101 includes functions equivalent to those of the access control rule storage section 1101 in the first exemplary embodiment. The application identifier storage section 2102 includes functions equivalent to those of the application identifier storage section 1102 in the first exemplary embodiment.

Referring to FIG. 7, the application data storage section 2103 stores the application identifier Aₓ of the application Aₓ acquired by the application adding section 2201, and the resource identifiers R_{A0} to R_{Ax} of all resources R_{A0} to R_{Ax}, used by the application Aₓ as a set. It should be noted that the set of the application identifier Aₓ and the resource identifiers R_{A0} to R_{Ax} of the resources R_{A0} to R_{Ax} used by the application Aₓ is referred to as the application data Aₓ.

The additional application storage section 2301 has functions equivalent to those of the additional application storage section 1301 in the first exemplary embodiment. The additional resource storage section 2302 has functions equivalent to those of the additional resource storage section 1302 in the first exemplary embodiment. The update access control rule storage section 2303 stores in advance an access control rule R_{y}′ (Ry′ is an integer not less than 0 and not more than R) for a resource R_{y} (R is an integer not less than 0 and not more than R) along with a resource identifier Ry of the resource R_{y} as a set.

The application adding section 2201 has functions equivalent to those of the application adding section 1201 in the first exemplary embodiment. The resource adding section 2202 includes functions equivalent to those of the resource adding section 1202 in the first exemplary embodiment. The access control attribute generating section 2203 has, in addition to functions equivalent to those of the access control attribute generating section 1203 in the first exemplary embodiment, a function of storing the set of the application identifier Aₓ and the resource identifiers R_{A0} to R_{Ax}, which is received from the application adding section 2201, in the application data storage section 2103 as the application data Aₓ.

The access control rule updating section 2204 has a function of acquiring the access control rule R_{y}′ corresponding to the resource identifier R_{y} from the update access control rule storage section 2303; changing an access control rule R_{y} for the resource R_{y} stored in the access control rule storage section 2101 to the access control rule R_{y}′; and transmitting the resource identifier R_{y} to the access control attribute regenerating section 2205. The access control attribute regenerating section 2205 has a function of being called by the access control rule updating section 2204, and referring to the application data storage section 2103 to sequentially acquire application data A_{y0} to A_{yx} (A_{y0} and A_{yx} are integers not less than 0 and not more than A, and A_{y0}≦A_{yx}) having the received resource identifier R_{y}; and a function of acquiring from the access control rule storage section 2101, access control rules R_{Ay0} to R_{Ayx} (R_{Ay0} and R_{Ayx} are integers not less than 0 and not more than R, and R_{Ay0}≦R_{Ayx}) corresponding to resource identifiers R_{Ay0} to R_{Ayx} included in the acquired application data A_{y0} to A_{yx} to generate access control attributes Ay0 to A_{yx} for applications corresponding to application identifiers A_{y0} to A_{yx}, and applying the access control attributes A_{y0} to A_{yx} to the secure OS 2000.

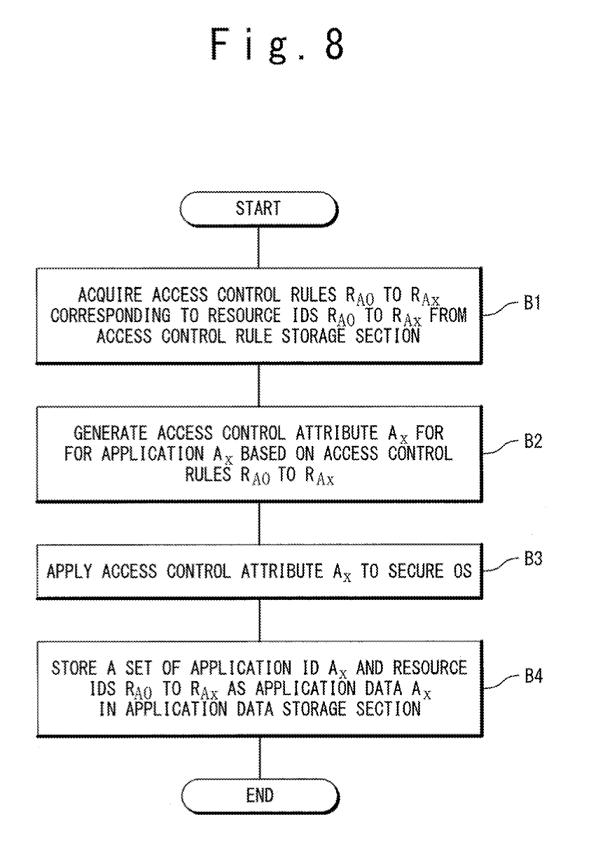

Next, referring to flowcharts of FIGS. 8 to 10, an operation of the information processing system according to the second exemplary embodiment will be described with differences from the first exemplary embodiment being focused on.

First, an operation of adding the application Aₓ will be described. The operation of the application adding section 2201 is the same as that of the application adding section 1201 illustrated in FIG. 3.

Similarly to the access control attribute generating section 1203 in the first exemplary embodiment, the access control attribute generating section 2203 acquires the access control rules R_{A0} to R_{Ax} from the access control rule storage section 2101 (Step B1 in FIG. 8) to generate the access control attribute Aₓ (Step B2), and applies the generated access control attribute Aₓ to the secure OS 2000 (Step B3). Then, the access control attribute generating section 2203 stores the set of the application identifier Aₓ and the resource identifiers R_{A0} to R_{Ax}, which is received from the application adding section 2201, in the application data storage section 2103 as the application data Aₓ (Step B4).

The operation of the resource adding section 2202 upon addition of a resource Rₓ is the same as that of the resource adding section 1202 illustrated in FIG. 5.

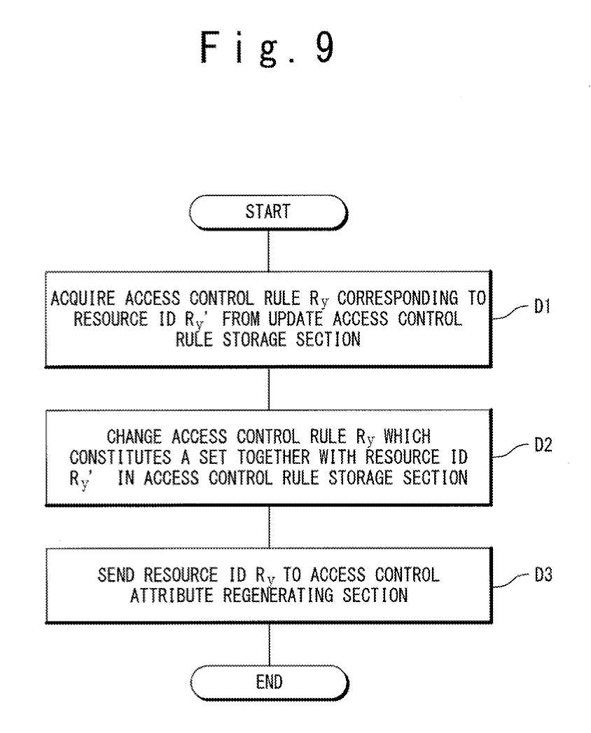

Next, an operation of updating the access control rule R_{y} for the resource R_{y} will be described. The access control rule updating section 2204 acquires the new access control rule R_{y}′ corresponding to the resource identifier R_{y} from the update access control rule storage section 2303 of the external storage apparatus 2300 (Step D1 in FIG. 9). The access control rule updating section 2204 changes the access control rule R_{y}, which is stored in the access control rule storage section 2101 and forms the set with the resource identifier R_{y}, to the access control rule R_{y}′ (Step D2), and transmits the resource identifier R_{y} to the access control attribute regenerating section 2205 (Step D3).

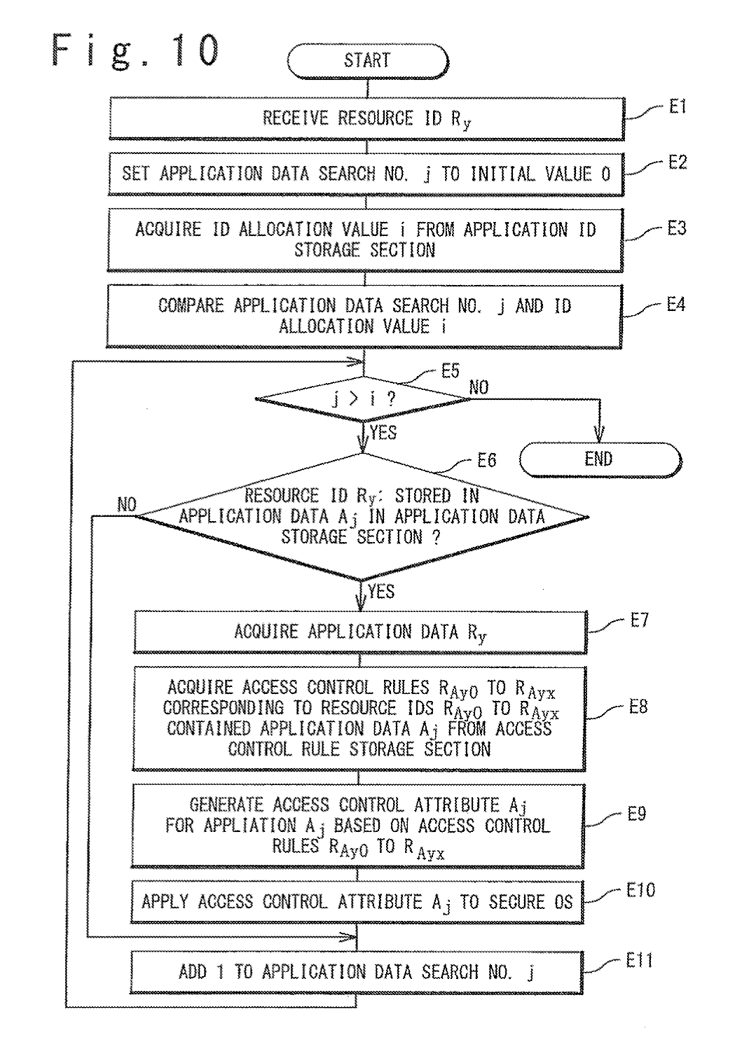

Subsequently, upon receipt of the resource identifier R_{y} from the access control rule updating section 2204 (Step E1 in FIG. 10), the access control attribute regenerating section 2205 sets an application data search number j (j is an integer not less than 0 and not more than A) to an initial value 0 (Step E2). The access control attribute regenerating section 2205 acquires an identifier allocation value i from the application identifier storage section 2102 (Step E3) to compare the application data search number j and the identifier allocation value i (Step E4). If the application data search number j is larger than the identifier allocation value i (NO in Step E5), the access control attribute regenerating section 2205 terminates an update process of the access control rule. On the other hand, if the identifier allocation value i is equal to or more than the application data search number j (YES in Step E5), the access control attribute regenerating section 2205 refers to application data Aⱼ in the application data storage section 2103 to determine whether or not the resource identifier R_{y} is included in the application data Aⱼ (Step E6).

If the resource identifier R_{y} is included in the application data Aⱼ (YES in Step E6), the access control attribute regenerating section 2205 acquires the application data Aⱼ (Step E7). The access control attribute regenerating section 2205 acquires the access control rules R_{Ay0} to R_{Ayx} corresponding to the resource identifiers R_{Ay0} to R_{Ayx} included in the acquired application data Aⱼ from the access control rule storage section 2101 (Step E8). The access control attribute regenerating section 2205 generates, on the basis of the acquired access control rules RAy0 to RAyx, an access control attribute Aⱼ for the application Aⱼ identified by an application identifier Aⱼ included in the application data Aⱼ (Step E9).

Subsequently, the access control attribute regenerating section 2205 applies the generated access control attribute Aⱼ to the secure OS 2000 (Step E10). When the access control attribute regenerating section 2205 applies the access control attribute Aⱼ to the secure OS 2000, or determines at Step E6 that the resource identifier Ry is not included in the application data Aⱼ, it adds 1 to the application data search number j (Step E11), and then returns to Step E5. The process at Step E5 to E11 is repeated in this manner until the application data search number j becomes larger than the identifier allocation value i at Step E5.

In the second exemplary embodiment, in addition to the effects of the first exemplary embodiment, an access control rule for a preliminarily stored resource can be changed by the access control rule updating section 2204, and an access control attribute for an application using the resource for which the access control rule has been changed can also be changed by the access control attribute regenerating section 2205.

### Third Exemplary Embodiment

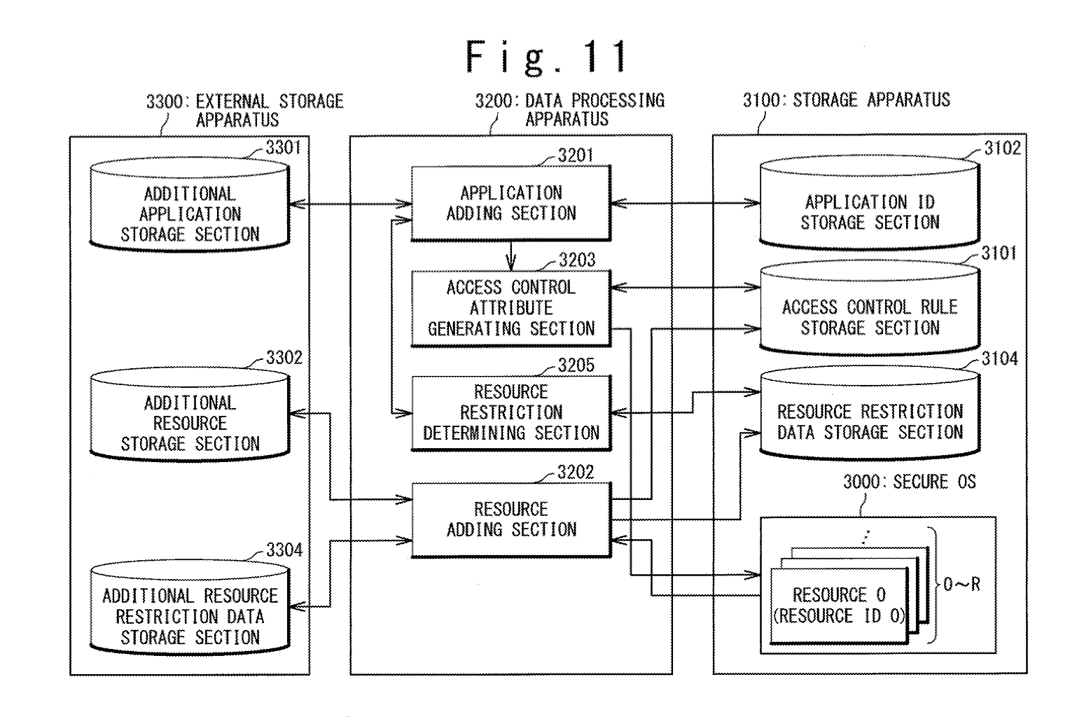

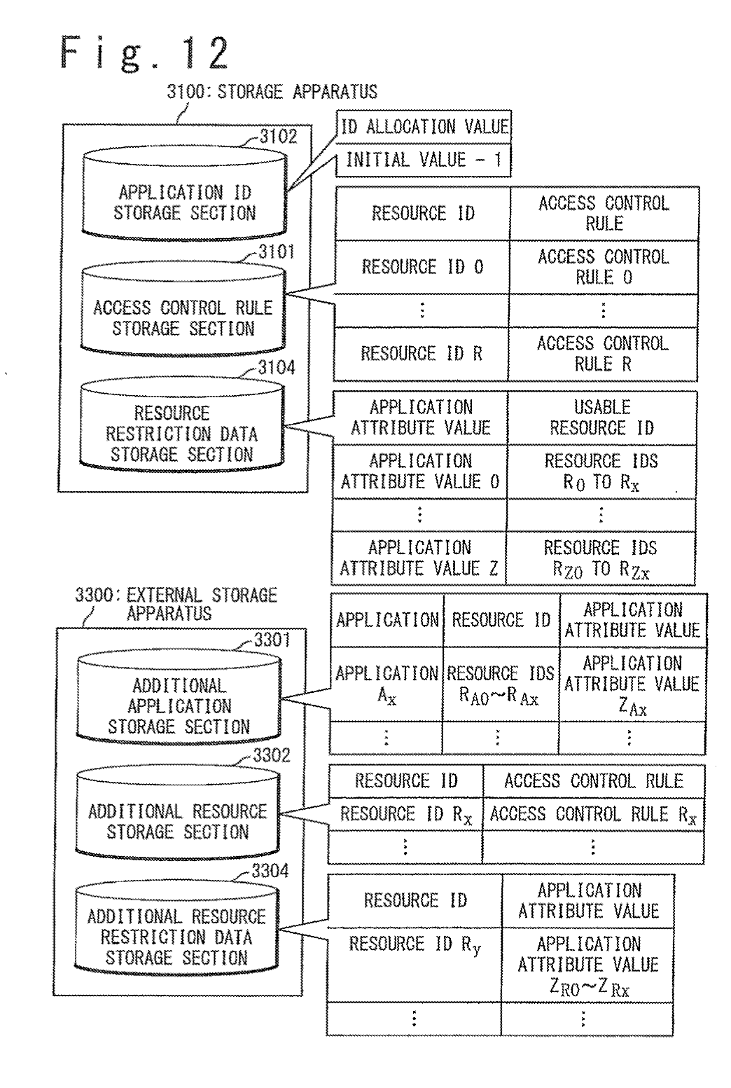

Next, the information processing system according to a third exemplary embodiment of the present invention will be described in detail referring to FIGS. 11 and 12. Referring to FIG. 11, the information processing system in the third exemplary embodiment of the present invention includes a storage apparatus 3100 and an external storage apparatus 3300 that store data, and a data processing apparatus 3200 that operates on the basis of a program control. The storage apparatus 3100 includes an access control rule storage section 3101, an application identifier storage section 3102, and a resource restriction data storage section 3104. Further, the storage apparatus 3100 stores a secure OS 3000 that is processed by the data processing apparatus 3200. The secure OS 3000 has functions equivalent to those of the secure OS 1000 in the first exemplary embodiment. The data processing apparatus 3200 includes an application adding section 3201, a resource adding section 3202, an access control attribute generating section 3203, and a resource restriction determining section 3205. The external storage apparatus 3300 includes an additional application storage section 3301, an additional resource storage section 3302, and an additional resource restriction data storage section 3304. The external storage apparatus 3300 is an apparatus accessible from the application adding section 3201 and the resource adding section 3202. As an example of the external storage apparatus 3300, there is an external storage medium such as an SD card, and a storage apparatus inside an information processing terminal connected via a network.

The access control rule storage section 3101 has functions equivalent to those of the access control rule storage section 1101 in the first exemplary embodiment. The application identifier storage section 3102 has functions equivalent to those of the application identifier storage section 1102 in the first exemplary embodiment.

Referring to FIG. 12, the resource restriction data storage section 3104 stores in advance as sets application attribute values 0 to Z (Z is an integer not less than 0 and not more than A) representing attributes of applications, and resource identifiers RZ0 to RZx (RZ0 and RZx are integers not less than 0 and not more than R, and RZ0≦RZx) of resources RZ0 to RZx available to the applications. An application attribute value indicates a creator of a corresponding application, or a security level of the application.

The additional application storage section 3301 stores in advance as a set the application Aₓ executable by the data processing apparatus 1200, the resource identifiers R_{A0} to R_{Ax} of all resources R_{A0} to R_{Ax} used by the application Aₓ, and an application attribute value Z_{Ax} (Z_{Ax} is an integer not less than 0 and not more than Z) of the application Aₓ. The additional resource storage section 3302 has functions equivalent to those of the additional resource storage section 1302 in the first exemplary embodiment. The additional resource restriction data storage section 3304 stores in advance as a set a resource identifier Rₓ of a resource Rₓ, and application attribute values Z_{R0} to Z_{Rx} (Z_{R0} and Z_{Rx} are integers not less than 0 and not more than Z, and Z_{R0}≦Z_{Rx}) of an application allowed to use the resource Rₓ.

The application adding section 3201 has, in addition to the functions of the application adding section 1201 in the first exemplary embodiment, a function of, upon acquisition of the application Aₓ and the resource identifiers R_{A0} to R_{Ax} from the additional application storage section 3301, acquiring the application attribute value Z_{Ax} (Z_{Ax} is an integer not less than 0 and not more than Z) of the application Aₓ, and calling the resource restriction determining section 3205 to determine whether or not to add the application Aₓ.

The resource adding section 3202 has, in addition to the functions of the resource adding section 1202 in the first exemplary embodiment, a function of acquiring from the additional resource restriction data storage section 3304 of the external storage apparatus 3300, the application attribute values Z_{R0} to Z_{Rx} of the applications allowed to use the resource Rₓ, which form a set with the resource identifier Rₓ, and adding the resource identifier Rₓ to a resource identifier corresponding to the application attribute values Z_{R0} to Z_{Rx} in the resource restriction data storage section 3104.

The access control attribute generating section 3203 has functions equivalent to those of the access control attribute generating section 1203 in the first exemplary embodiment.

The resource restriction determining section 3205 has a function of receiving the resource identifiers R_{A0} to R_{Ax} and the application attribute value Z_{Ax} of the application Aₓ from the application adding section 3201; referring to the resource restriction data storage section 3104 to acquire resource identifiers R_{ZA0} to R_{ZAx} corresponding to the application attribute value Z_{Ax}; and determining whether or not the resource identifiers R_{A0} to R_{Ax} are included in the resource identifiers R_{ZA0} to R_{ZAx}.

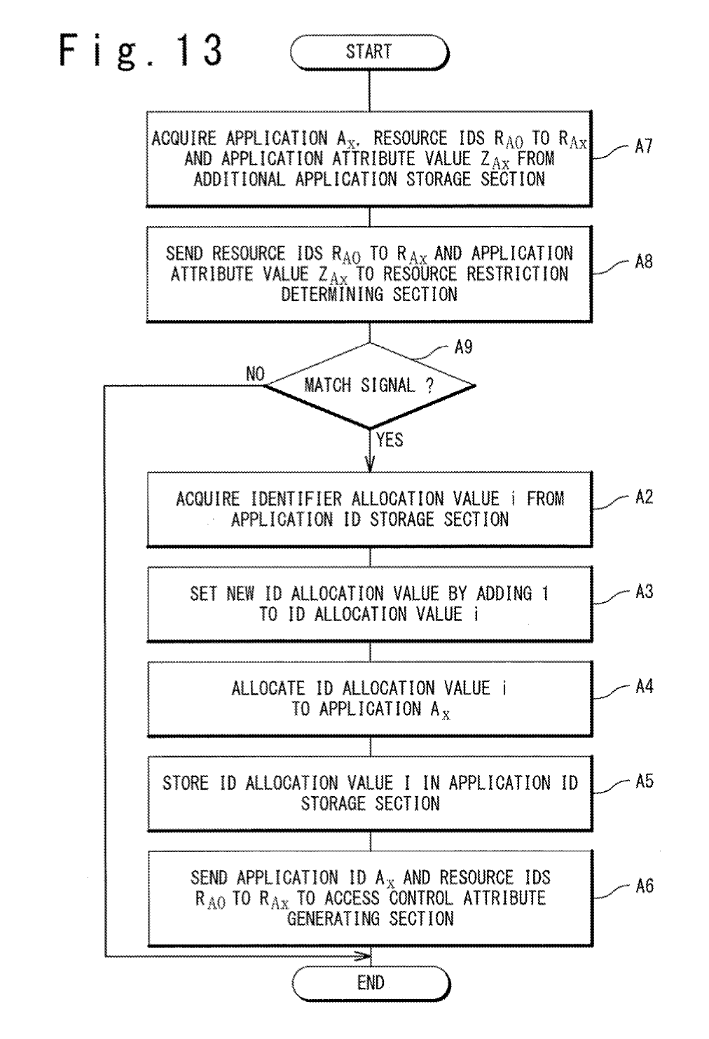

Next, referring to flowcharts of FIGS. 13 to 15, an operation of the information processing system in the third exemplary embodiment will be described with differences from the first exemplary embodiment being focused on.

First, an operation of adding the application Aₓ will be described. The application adding section 3201 acquires the application Aₓ, the resource identifiers R_{A0} to R_{Ax} of the resources R_{A0} to R_{Ax} used by the application Aₓ, and the application attribute value Z_{Ax} of the application Aₓ from the additional application storage section 3301 of the external storage apparatus 3300 (Step A7 in FIG. 13). The application adding section 3201 transmits the acquired resource identifiers R_{A0} to R_{Ax} and the application attribute value Z_{Ax}, to the resource restriction determining section 3205 (Step A8), and waits until receiving a match signal or a mismatch signal (Step A9).

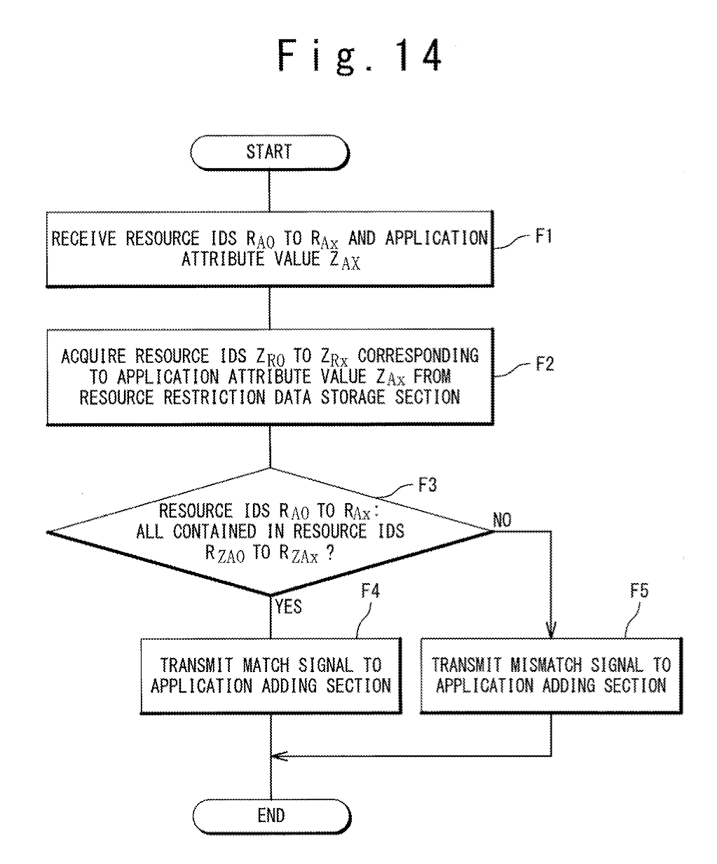

Upon receipt of the resource identifiers R_{A0} to R_{Ax} and the application attribute value Z_{Ax} from the application adding section 3201 (Step F1 in FIG. 14), the resource restriction determining section 3205 refers to the resource restriction data storage section 3104 to acquire the resource identifiers R_{ZA0} to R_{ZAx} corresponding to the application attribute value Z_{Ax} from the resource restriction data storage section 3104 (Step F2). The resource restriction determining section 3205 compares the acquired resource identifiers R_{ZA0} to R_{ZAx} and the received resource identifiers R_{A0} to R_{Ax} to determine whether or not the resource identifiers R_{A0} to R_{Ax} are all included in the resource identifiers R_{ZA0} to R_{ZAx} (Step F3). If the resource identifiers R_{A0} to R_{Ax} are all included in the resource identifiers R_{ZA0} to R_{ZAx} (YES in Step F3), the resource restriction determining section 3205 transmits the match signal to the application adding section 3201 (Step F4), whereas if at least a part of the resource identifiers R_{A0} to R_{Ax} is not included in the resource identifiers R_{ZA0} to R_{ZAx} (NO in Step F3), the resource restriction determining section 3205 transmits the mismatch signal to the application adding section 3201 (Step F5).

If the application adding section 3201 receives the mismatch signal from the resource restriction determining section 3205 (receipt of mismatch signal in Step A9), it terminates application adding processing. On the other hand, when the application adding section 3201 receives the match signal (receipt of match signal in Step A9), the control flow proceeds to Step A2.

The steps subsequent to Step A2 are the same as those in the first exemplary embodiment. That is, the application adding section 3201 acquires an identifier allocation value i from the application identifier storage section 3102 (Step A2); sets a value obtained by adding 1 to the identifier allocation value i to a new identifier allocation value i (Step A3); and allocates the new identifier allocation value i to the application Aₓ obtained from the additional application storage section 3301 as the application identifier Aₓ (Step A4). The application adding section 3201 stores the identifier allocation value i in the application identifier storage section 3102 (Step A5), and transmits the application identifier Aₓ and the resource identifiers R_{A0} to R_{Ax} to the access control attribute generating section 3203 (Step A6).

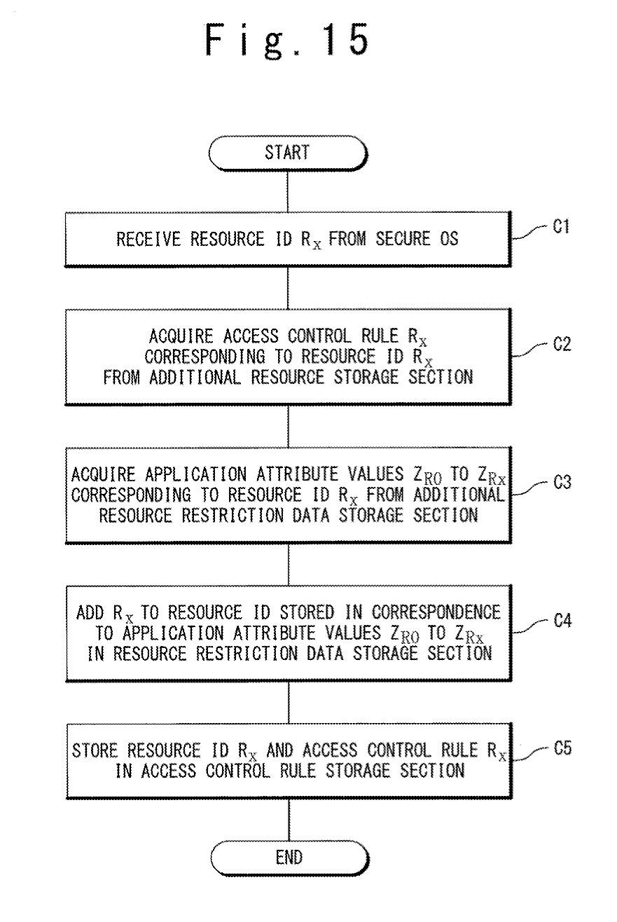

Next, an operation of adding the resource Rₓ will be described. When the resource Rₓ is added, the resource adding section 3202 receives the resource identifier Rₓ from the secure OS 3000 (Step C1 in FIG. 15). The resource adding section 3202 acquires the access control rule Rₓ corresponding to the resource identifier Rₓ from the additional resource storage section 3302 of the external storage apparatus 3300 (Step C2). The resource adding section 3202 acquires from the additional resource restriction data storage section 3304 of the external storage apparatus 3300, the application attribute values Z_{R0} to Z_{Rx} (application attribute values Z_{R0} to Z_{Rx} corresponding to the resource identifier Rₓ) of the applications allowed to use the resource Rₓ (Step C4). Also, the resource adding value 3202 adds the resource identifier Rₓ to resource identifiers that are stored in the resource restriction data storage section 3104 correspondingly to the application attribute values Z_{R0} to Z_{Rx} (Step C5). Further, the resource adding value 3202 stores the resource identifier Rₓ and the access control rule Rₓ in the access control rule storage section 3101 as a set (Step C3).

In the present exemplary embodiment, in addition to the effects of the first exemplary embodiment, available resources can be restricted by the resource restriction determining section 3205, depending on an attribute of an application. As an example of the application attribute, a creator of the application, a security level depending on reliability of the application, or the like is possible.

### Fourth Exemplary Embodiment

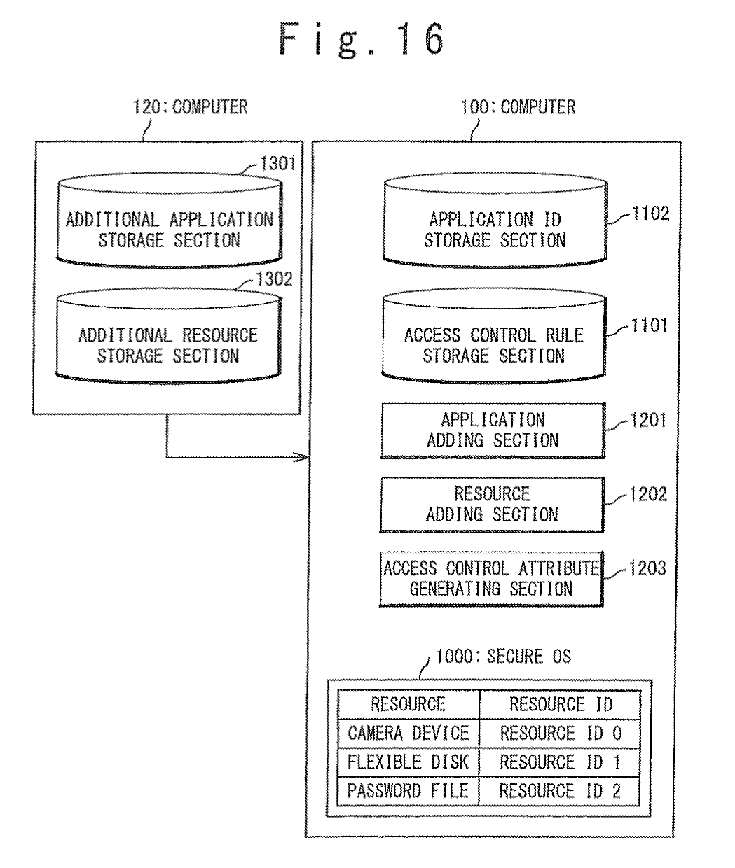

Next, the information processing system according to a fourth exemplary embodiment of the present invention will be described referring to FIGS. 16 to 18. The fourth exemplary embodiment is one that more specifically describes the first exemplary embodiment.

As illustrated in FIG. 16, the information processing system in the fourth exemplary embodiment of the present invention includes a computer 100 that corresponds to the storage apparatus 1100 and the data processing apparatus 1200 of the first exemplary embodiment and operates on the basis of a program control; and a computer 120 that corresponds to the external storage apparatus 1300 and operates on the basis of the program control. The computer 100 is connected to the computer 120 via a network.

On the computer 100, the secure OS 1000 operates. In the present exemplary embodiment, SELinux is used as the secure OS 1000; however, another type of secure OS may be used. The secure OS 1000 manages a camera device, a flexible disk, and a password file as resources to be accessed by an application. The camera device is allocated with a resource identifier 0, a flexible disk with a resource identifier 1, and a password file with a resource identifier 2. Also, in the case where a CD drive is added as a resource managed by the secure OS 1000, it is allocated with a resource identifier 3.

On the computer 100, the application adding section 1201, the resource adding section 1202, and the access control attribute generating section 1203 described in the first exemplary embodiment operate. In a memory area of the computer 100, the access control rule storage section 1101 and the application identifier storage section 1102 described in the first exemplary embodiment are provided.

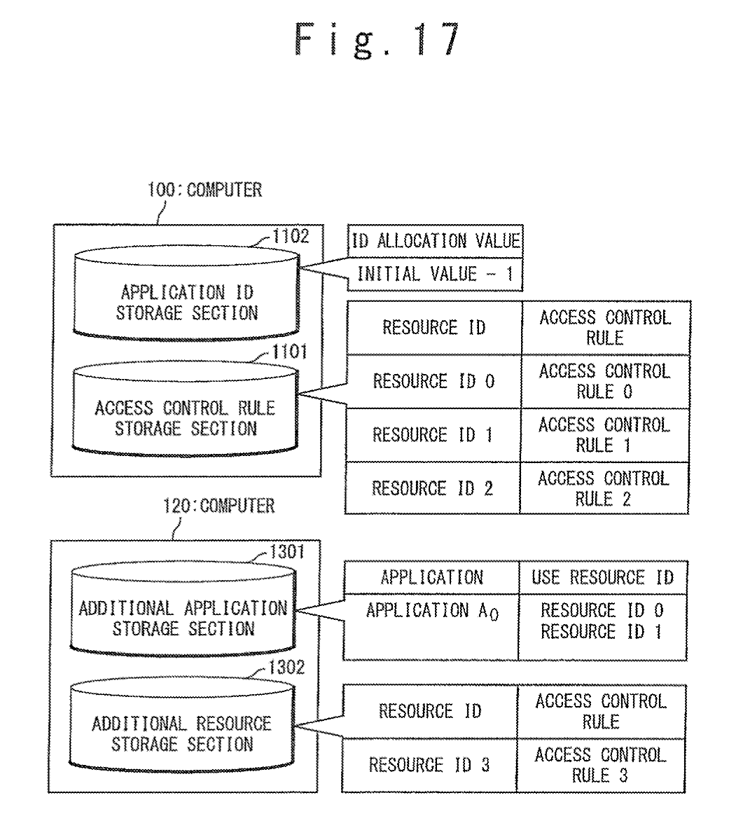

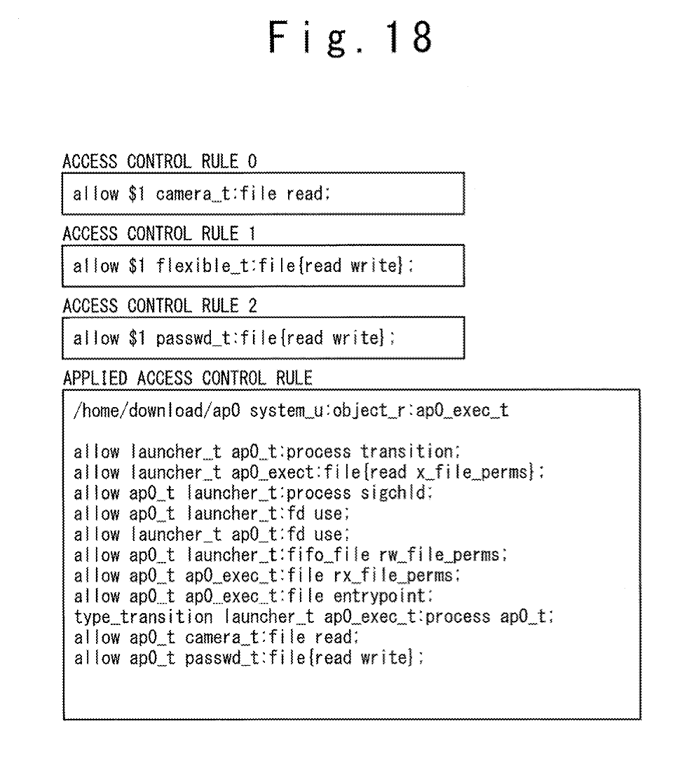

Referring to FIG. 17, in the access control rule storage section 1101 are stored an access control rule 0 for an application to use the camera device, an access control rule 1 for an application to use the flexible disk, and an access control rule 2 for an application to use the password file. Contents of the access control rules 0 to 2 are as illustrated in FIG. 18.

In the application identifier storage section 1102, an identifier allocated to an application is stored. The application identifier storage section 1102 stores −1 in advance as an initial value of the identifier. In a memory area of the computer 120, the additional application storage section 1301 and the additional resource storage section 1302 described in the first exemplary embodiment are arranged. In the additional application storage section 1301, the application A₀, and the resource identifier 0 of the camera device and the resource identifier 1 of the flexible disk used by the application A₀ are stored as a set. In the additional resource storage section 1302, an access control rule 3 that is an access control rule for the CD drive is stored along with the resource identifier 3 as a set.

Next, an operation for the case where the application A₀ is added in the information processing system of the present exemplary embodiment will be described.

The application adding section 1201 acquires the application A₀, and resource identifiers 0 and 1 of the resources used by the application A₀ from the additional application storage section 1301 of the computer 120 (Step A1 in FIG. 3). Then, the application adding section 1201 refers to the application identifier storage section 1102 to acquire an identifier allocation value i=−1 (Step A2); sets a value i=0 obtained by adding 1 to the identifier allocation value i=−1 to a new identifier allocation value (Step A3); and allocates the new identifier allocation value i=0 to the application A₀ as an application identifier A₀ (Step A4). The application adding section 1201 stores the identifier allocation value i=0 in the application identifier storage section 1102 (Step A5), and transmits the application identifier 0, and the resource identifiers 0 and 1 to the access control attribute generating section 1203 (Step A6).

The access control attribute generating section 1203 acquires the access control rules 0 and 1 corresponding to the received resource identifiers 0 and 1 from the access control rule storage section 1101 (Step B1 in FIG. 4). The access control attribute generating section 1203 generates, on the basis of the acquired access control rules 0 and 1, an access control attribute for the application A₀ (Step B2), and applies the generated access control attribute to the secure OS 1000 (Step B3). An access control rule corresponding to the applied access control attribute is as illustrated in FIG. 18.

Next, an operation for the case where the CD drive is added as a resource managed by the secure OS 1000 will be described.

The resource adding section 1202 receives the resource identifier 3 of the CD drive from the secure OS 1000 (Step C1 in FIG. 5). The resource adding section 1202 acquires the access control rule 3 corresponding to the resource identifier 3 from the additional resource storage section 1302 of the computer 120 (Step C2). The resource adding section 1202 stores the resource identifier 3 and the access control rule 3 in the access control rule storage section 1101 as a set (Step C3).

### Fifth Exemplary Embodiment

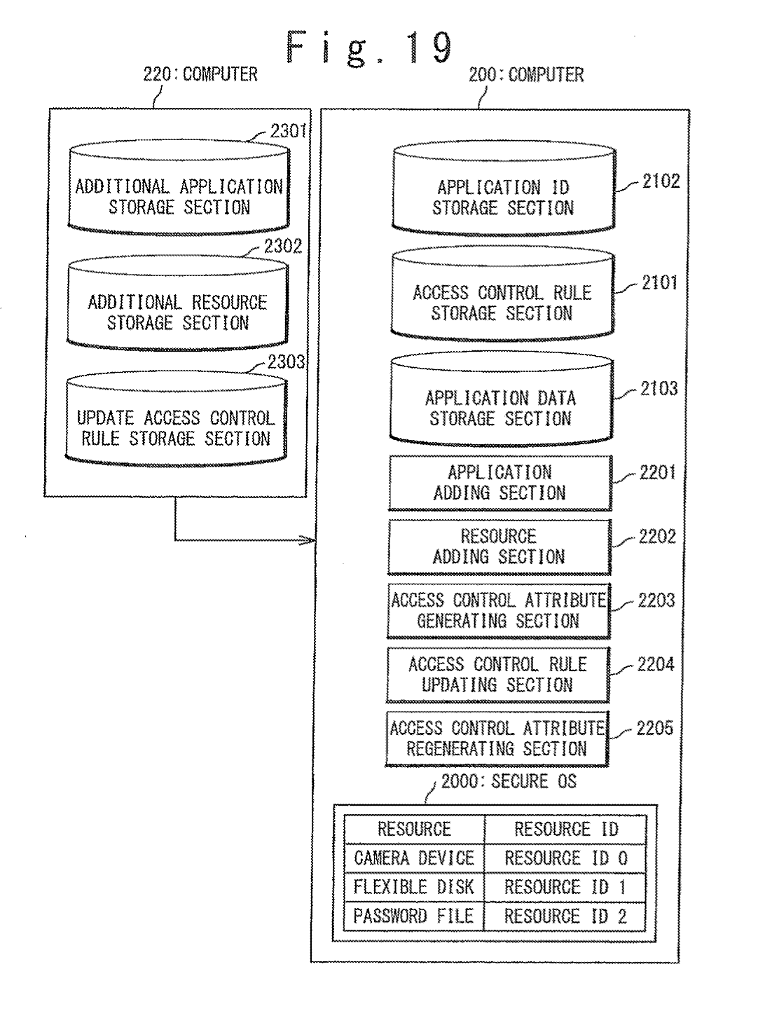

Next, a fifth exemplary embodiment of the present invention will be described referring to FIGS. 19 to 21. The fifth exemplary embodiment is one that more specifically describes the second exemplary embodiment.

As illustrated in FIG. 19, the information processing system in the fifth exemplary embodiment of the present invention includes a computer 200 that corresponds to the storage apparatus 2100 and a data processing apparatus 2000 of the second exemplary embodiment and operates on the basis of a program control; and a computer 220 that corresponds to the external storage apparatus 2300 and operates on the basis of the program control. The computer 200 is connected to the computer 220 via a network.

On the computer 200, the secure OS 2000 operates. In the present exemplary embodiment, SELinux is used as the secure OS 2000; however, another type of secure OS may be used. The secure OS 2000 manages a camera device, a flexible disk, and a password file as resources to be accessed by an application. The camera device is allocated with the resource identifier 0, a flexible disk with the resource identifier 1, and a password file with the resource identifier 2.

On the computer 200, the application adding section 2201, the resource adding section 2202, the access control attribute generating section 2203, the access control rule updating section 2204, and the access control attribute regenerating section 2205 described in the second exemplary embodiment operate. In a memory area of the computer 200, the access control rule storage section 2101, the application identifier storage section 2102, and the application data storage section 2103 described in the second exemplary embodiment are arranged.

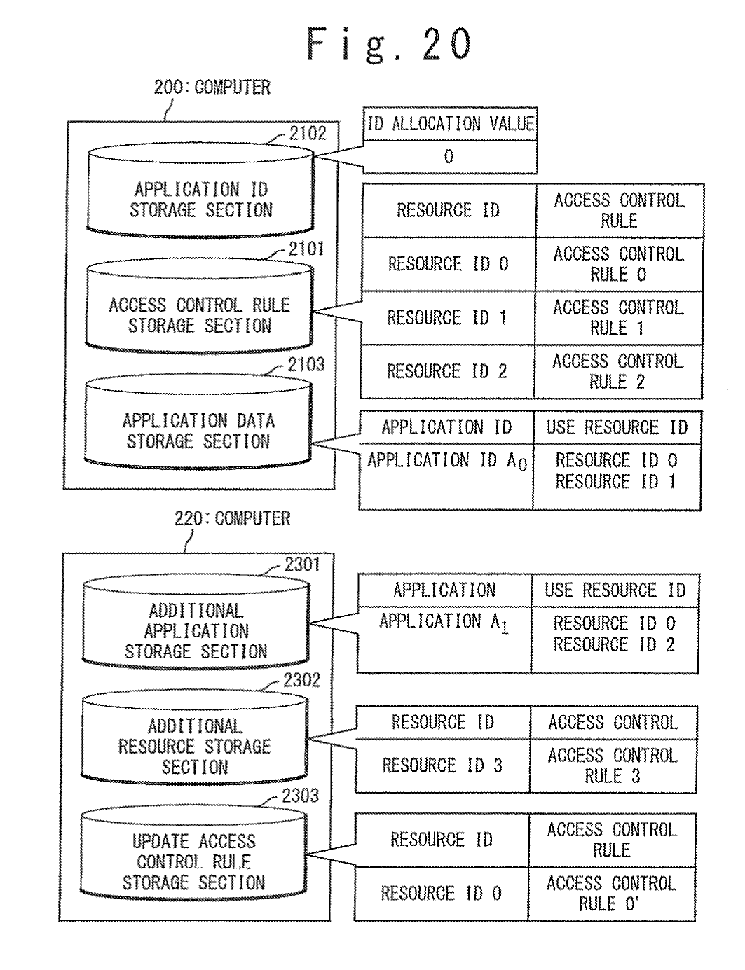

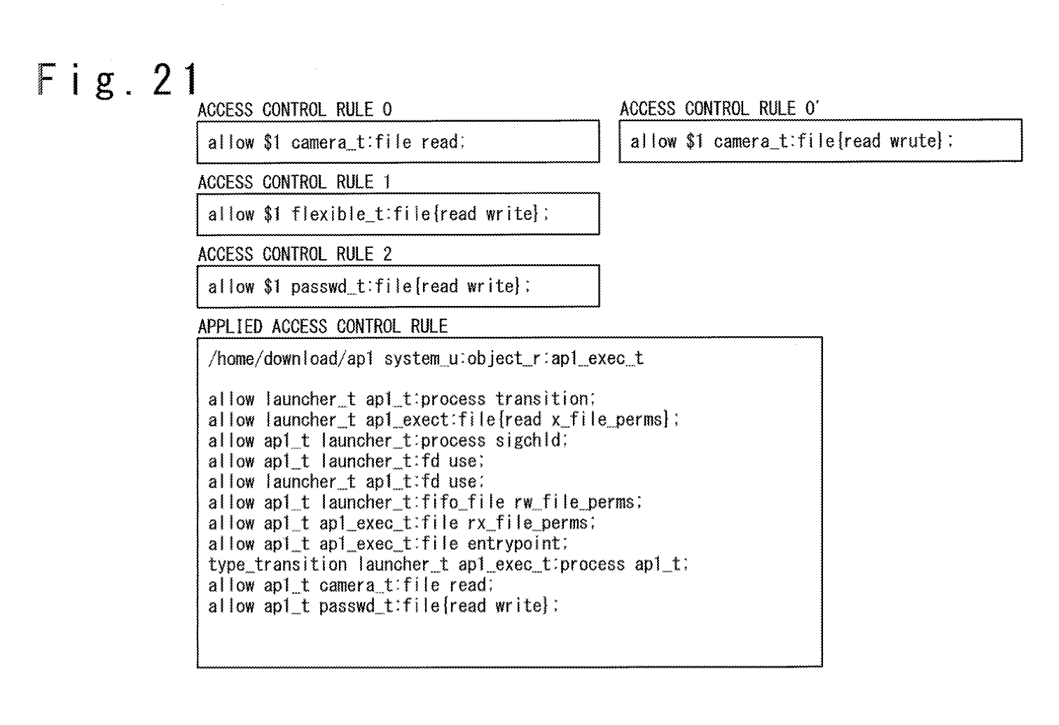

Referring to FIG. 20, in the access control rule storage section 2101 are stored the access control rule 0 for an application to use the camera device, the access control rule 1 for an application to use the flexible disk, and the access control rule 2 for an application to use the password file. Contents of the access control rules 0 to 2 are as illustrated in FIG. 21. In the application data storage section 2103 are stored as application data 0, the application identifier A₀ of the application A₀, and resource identifiers 0 and 1 as a set.

In a memory area of the computer 220, the additional application storage section 2301, the additional resource storage section 2302, and the update access control rule storage section 2303 described in the second exemplary embodiment are arranged. In the additional application storage section 2301, an application A₁, and the resource identifier 0 of the camera device and the resource identifier 2 of the password file used upon execution of the application A₁ are stored as a set. In the additional resource storage section 2302, the access control rule 3 that is an access control rule for a CD drive is stored along with the resource identifier 3 as a set. In the update access control rule storage section 2303, the resource identifier 0 of the camera device, and an access control rule 0′ that is a new access control rule for the camera device are stored as a set. A content of the access control rule 0′ is as illustrated in FIG. 21.

Next, an operation for the case where the application A₁ is added in the information processing system of the present exemplary embodiment will be described.

The application adding section 2201 acquires the application A₁, and the resource identifiers 0 and 2 of the resources used by the application A₁ from the additional application storage section 2301 of the computer 220. Then, the application adding section 2201 refers to the application identifier storage section 2102 to acquire an identifier allocation value i=0; sets a value i=1 obtained by adding 1 to the identifier allocation value i=0 as a new identifier allocation value; and allocates the new identifier allocation value i=1 to the application A₁ as an application identifier A₁. The application adding section 2201 stores the identifier allocation value i=1 in the application identifier storage section 2102, and transmits the application identifier A₁ and the resource identifiers 0 and 2 to the access control attribute generating section 2203.

The access control attribute generating section 2203 acquires the access control rules 0 and 2 corresponding to the received resource identifiers 0 and 2 from the access control rule storage section 2101 (Step B1 in FIG. 8). The access control attribute generating section 2203 generates, on the basis of the acquired access control rules 0 and 2, an access control attribute for the application A₁ (Step B2), and applies the generated access control attribute to the secure OS 2000 (Step B3). An access control rule corresponding to the applied access control attribute is as illustrated in FIG. 21. Subsequently, the access control attribute generating section 2203 stores the set of the application identifier A₁ and the resource identifiers 0 and 2 in the application data storage section 2103 as application data (Step B4).

Next, an operation of updating the access control rule for the camera device after the addition of the application A₁ will be described.

The access control rule updating section 2204 acquires the access control rule 0′ corresponding to the resource identifier 0 of the camera device from the update access control rule storage section 2203 of the computer 220 (Step D1 in FIG. 9). The access control rule updating section 2204 changes the access control rule 0, which is stored in the access control rule storage section 2101 and forms a set with the resource identifier 0, to the access control rule 0′ (Step D2), and transmits the resource identifier 0 to the access control attribute regenerating section 2205 (Step D3).

Upon receipt of the resource identifier 0 from the access control rule updating section 2204 (Step E1 in FIG. 10), the access control attribute regenerating section 2205 sets the application data search number j to the initial value 0 (Step E2). The access control attribute regenerating section 2205 acquires the identifier allocation value i=1 from the application identifier storage section 2102 (Step E3) to compare the application data search number j=0 and the identifier allocation value i=1 (Step E4). The identifier allocation value i=1 is larger than the application data search number j=0, and therefore the access control attribute regenerating section 2205 refers to the application data A₀ in the application data storage section 2103 to determine whether or not the resource identifier 0 is included in the application data A₀ (Step E6). The resource identifier 0 is included in the application data A₀, and therefore the access control attribute regenerating section 2205 acquires the application data A₀ (Step E7).

The access control attribute regenerating section 2205 acquires the access control rules 0 and 1 corresponding to the resource identifiers 0 and 1 included in the acquired application data A₀ from the access control rule storage section 2101 (Step E8). The access control attribute regenerating section 2205 generates, on the basis of the acquired access control rules 0 and 1, an access control attribute for the application A₀ identified by the application identifier A₀ (Step E9). The access control attribute regenerating section 2205 applies the generated access control attribute to the secure OS 2000 (Step E10).

Then, the access control attribute regenerating section 2205 adds 1 to the application data search number j=0 to make it j=1 (Step E11), and compares the application data search number j=1 and the identifier allocation value i=1 acquired from the application identifier storage section 2102. The application data search number j=1 is equal to the identifier allocation value i=1, and therefore the access control attribute regenerating section 2205 refers to application data A₁ in the application data storage section 2103 to determined whether or not the resource identifier 0 is included in the application data A₁ (Step E6). The resource identifier 0 is included in the application data A₁, and therefore the access control attribute regenerating section 2205 acquires the application data A₁ (Step E7).

The access control attribute regenerating section 2205 acquires the access control rules 0 and 2 corresponding to the resource identifiers 0 and 2 included in the acquired application data A₁ from the access control rule storage section 2101 (Step E8). The access control attribute regenerating section 2205 generates, on the basis of the acquired access control rules 0 and 2, an access control attribute for the application A₁ identified by the application identifier A₁ (Step E9). The access control attribute regenerating section 2205 applies the generated access control attribute to the secure OS 2000 (Step E10).

Subsequently, the access control attribute regenerating section 2205 adds 1 to the application data search number j=1 to set it j=2 (Step E11), and compares the application data search number j=2 and the identifier allocation value i=1. The application data search number j=2 is larger than the identifier allocation value i=1, and therefore the access control attribute regenerating section 2205 terminates access control rule updating processing.

### Sixth Exemplary Embodiment

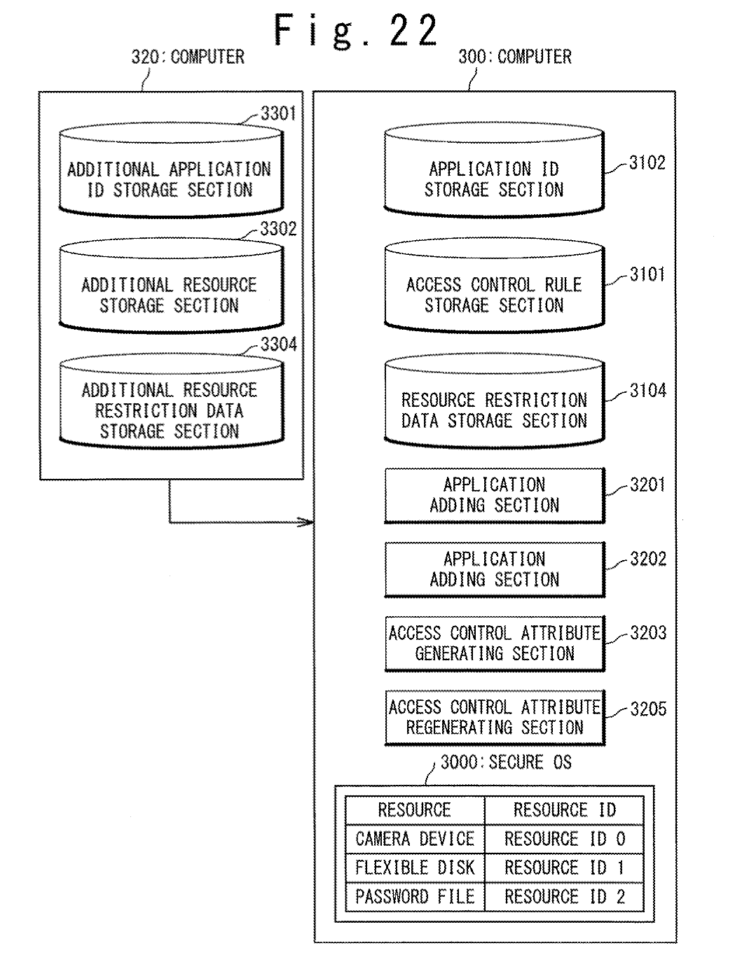

Next, a sixth exemplary embodiment of the present invention will be described referring to FIGS. 22 to 25. The sixth exemplary embodiment is one that more specifically describes the third exemplary embodiment.

As illustrated in FIG. 22, the information processing system in the sixth exemplary embodiment of the present invention includes a computer 300 that corresponds to the storage apparatus 3100 and the data processing apparatus 3200 of the third exemplary embodiment and operates on the basis of a program control; and a computer 320 that corresponds to the external storage apparatus 3300 and operates on the basis of the program control. The computer 300 is connected to the computer 320 via a network.

On the computer 300, the secure OS 3000 operates. In the present exemplary embodiment, SELinux is used as the secure OS 3000; however, another type of secure OS may be used. The secure OS 3000 manages a camera device, a flexible disk, and a password file as resources to be accessed by an application. The camera device is allocated with the resource identifier 0, a flexible disk with the resource identifier 1, and a password file with the resource identifier 2. Also, if a CD drive is added as a resource managed by the secure OS 3000, the resource identifier 3 is allocated.

On the computer 300, the application adding section 3201, the resource adding section 3202, the access control attribute generating section 3203, and the resource restriction determining section 3205 described in the third exemplary embodiment operate. In a memory area of the computer 300, the access control rule storage section 3101, the application identifier storage section 3102, and the resource restriction data storage section 3104 described in the third exemplary embodiment are arranged.

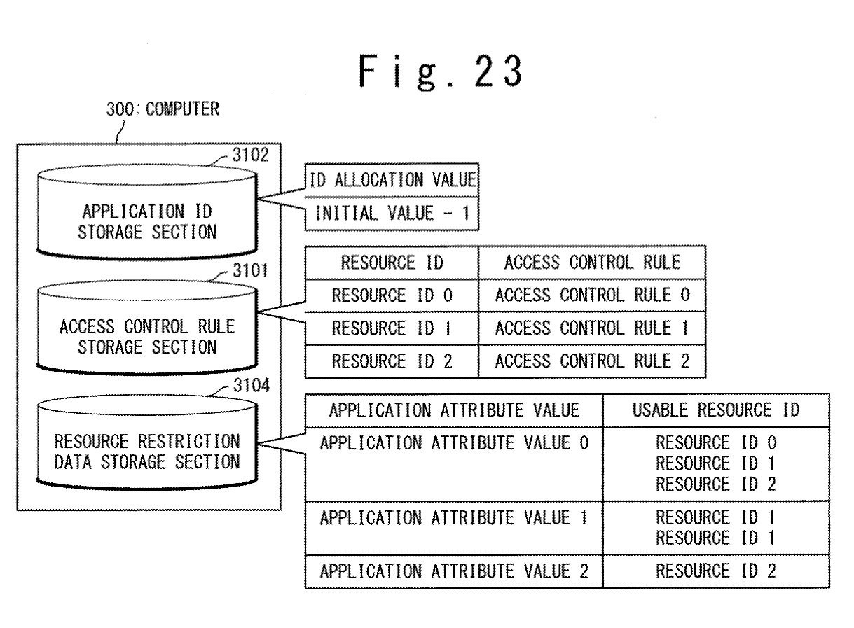

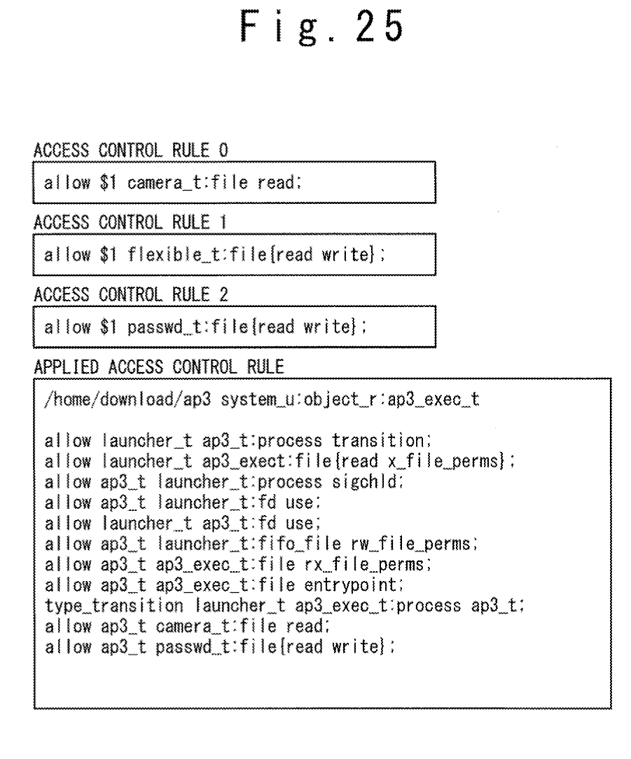

Referring to FIG. 23, in the access control rule storage section 3101 are stored the access control rule 0 for an application to use the camera device, the access control rule 1 for an application to use the flexible disk, the access control rule 2 for an application to use the password file. Contents of the access control rules 0 to 2 are as illustrated in FIG. 25. In the application identifier storage section 3102, an identifier allocated to an application is stored. The application identifier storage section 3102 stores −1 in advance as an initial value of the identifier.

In the resource restriction data storage section 3104, an application attribute value, and a resource identifier of a resource available to a corresponding application are stored as a set. In a memory area of the computer 320, the additional application storage section 3301, the additional resource storage section 3302, and the additional resource restriction data storage section 3304 described in the third exemplary embodiment are arranged.

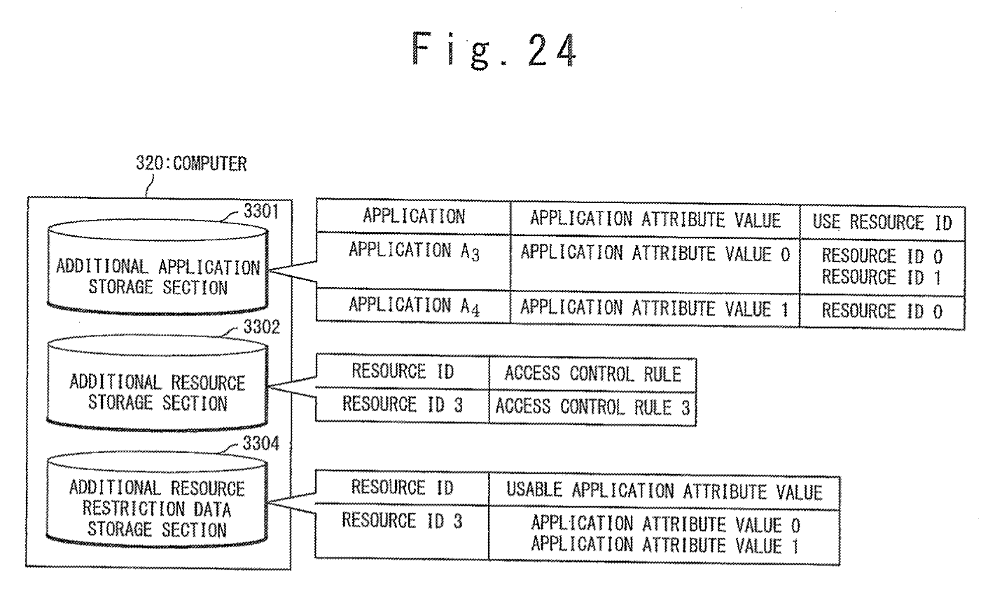

Referring to FIG. 24, in the additional application storage section 3301, an application A₃, the application attribute value 0 of the application A₃, and the resource identifier 0 of the camera device and the resource identifier 1 of the flexible disk used upon execution of the application A₃ are stored as a set, and further an application A₄, an application attribute value 1 of the application A₄, and the resource identifier 0 of the camera device used upon execution of the application A₄ are stored as a set.

In the additional resource storage section 3302, the access control rule 3 that is an access control rule for the CD drive is stored along with the resource identifier 3 as a set. In the additional resource restriction data storage section 3304, the application attribute values 0 and 1 of the applications allowed to use the CD drive are stored along with the resource identifier 3 as a set.

Next, an operation of adding the application A₃ in the information processing system of the present exemplary embodiment will be described.

The application adding section 3201 acquires the application A₃, the resource identifiers 0 and 1 of the resources used by the application A₃, and the application attribute value 0 of the application A₃ from the additional application storage section 3301 of the computer 320 (Step A7 in FIG. 13). The application adding section 3201 transmits the acquired resource identifiers 0 and 1 and the application attribute value 0 to the resource restriction determining section 3205 (Step A8), and waits until receiving the match signal or the mismatch signal (Step A9).

Upon receipt of the resource identifiers 0 and 1 and the application attribute value 0 (Step F1 in FIG. 14), the resource restriction determining section 3205 acquires the resource identifiers 0 to 2 corresponding to the application attribute value 0 from the resource restriction data storage section 3104 (Step F2). The resource restriction determining section 3205 compares the resource identifiers 0 to 2 acquired from the resource restriction data storage section 3104 and the resource identifiers 0 and 1 received from the application adding section 3201 (Step F3). The resource identifiers 0 and 1 received from the application adding section 3201 are included in the resource identifiers 0 to 2 acquired from the resource restriction data storage section 3104, and therefore the resource restriction determining section 3205 transmits the match signal to the application adding section 3201 (Step F4).

Upon receipt of the match signal, the application adding section 3201 acquires an identifier allocation value i=−1 from the application identifier storage section 3102 (Step A2 in FIG. 13); sets a value i=0 obtained by adding 1 to the identifier allocation value i=−1 as a new identifier allocation value (Step A3); and allocates the new identifier allocation value i=0 to the application A₃ acquired from the additional application storage section 3301 as an application identifier A₃ (Step A4). The application adding section 3201 stores the identifier allocation value i=0 in the application identifier storage section 3102 (Step A5), and transmits the application identifier A₃ and the resource identifiers 0 and 1 to the access control attribute generating section 3203 (Step A6).

The access control attribute generating section 3203 acquires the access control rules 0 and 1 corresponding to the received resource identifiers 0 and 1 from the access control rule storage section 3101. The access control attribute generating section 1023 generates, on the basis of the acquired access control rules 0 and 1, an access control attribute for the application A₃, and applies the generated access control attribute to the secure OS 3000. An access control rule corresponding to the applied access control attribute is as illustrated in FIG. 25.

Next, an operation of adding the application A₄ in the information processing system of the present exemplary embodiment will be described.

The application adding section 3201 acquires the application A₄, the resource identifier 0 of the resource used by the application A₄/and the application attribute value 1 of the application A₄ from the additional application storage section 3301 of the computer 320 (Step A7 in FIG. 13). The application adding section 3201 transmits the acquired resource identifier 0 and the application attribute value 1 to the resource restriction determining section 3205 (Step A8), and waits until receiving the match signal or the mismatch signal (Step A9).

Upon receipt of the resource identifier 0 and the application attribute value 1 (Step F1 in FIG. 14), the resource restriction determining section 3205 acquires the resource identifiers 1 and 2 corresponding to the application attribute value 1 from the resource restriction data storage section 3104 (Step F2). The resource restriction determining section 3205 compares the resource identifiers 1 and 2 acquired from the resource restriction data storage section 3104 and the resource identifier 0 received from the application adding section 3201 (Step F3). The resource identifier 0 received from the application adding section 3201 is not included in the resource identifiers 1 and 2 acquired from the resource restriction data storage section 3104, and therefore the resource restriction determining section 3205 transmits the mismatch signal to the application adding section 3201 (Step F5). Upon receipt of the mismatch signal, the application adding section 3201 terminates application adding processing.

Next, an operation for the case where the CD drive is added as a resource managed by the secure OS 3000 will be described.

The resource adding section 3202 receives the resource identifier 3 of the CD drive from the secure OS 3000 (Step C1 in FIG. 15). The resource adding section 3202 acquires the access control rule 3 corresponding to the resource identifier 3 from the additional resource storage section 3302 of the computer 320 (Step C2). The resource adding section 3202 acquires the application attribute values 0 and 1 (application attribute values corresponding to the resource identifier 3) of the applications allowed to use the CD drive from the additional resource restriction data storage section 3304 (Step C4).

Further, the resource adding section 3202 adds the resource identifier 3 to the resource identifiers that are stored in the resource restriction data storage section 3104 correspondingly to the application attribute values 0 and 1 (Step C5). The resource adding value 3202 stores the resource identifier 3 and the access control rule 3 in the access control rule storage section as a set (Step C3).

It should be noted that the information processing system of any of the first to sixth exemplary embodiments can be achieved by a computer provided with a CPU, a storage apparatus and interface with the outside, and a program controlling these hardware resources. In such a computer, an information processing program for achieving an information processing method of the present invention is provided with being recorded in a recording medium such as a flexible disk, a CD-ROM, a DVD-ROM, or a memory card. The CPU writes the program having been read from the recording medium into the storage apparatus, and executes the processes described in any of the first to sixth exemplary embodiments according to the program. Regarding the computer, there may be a single body, or alternatively a plurality of bodies as described in any of the third to sixth exemplary embodiments.

The present invention can be applied to an access control attribute setting section for a secure OS. It should be noted that the information processing system can be applied to applications from a unit like a personal computer to a built-in computer in a mobile communication terminal or the like such as a cellular phone or a PDA, a game console, or a multi-function copier.

According to the present invention, a resource identifier of a resource managed by a secure OS, and an access control rule upon use of the resource corresponding to the resource identifier by an application are stored in advance in the access control rule storage section as a set, and therefore it is sufficient that information to be newly added to generate an access control attribute of an application to be added is only a resource identifier of a resource used by the application. Accordingly, even if a creator of the application to be added does not know a configuration of the secure OS, he/she can generate the access control attribute. Also, even if the creator of the application to be added does not know a change in configuration of the secure OS, he/she can generate the access control attribute. Further, the creator of the application to be added can generate the access control attribute without generating an access control rule.

It should be noted that, in addition to the above, there is provided an information processing program instructing an information processing apparatus to perform a procedure that, upon addition of an application to the information processing apparatus, acquires an identifier of a resource of the information processing apparatus, which is used by the application; generates a rule appropriate to the application on the basis of a rule defined in advance in correspondence to the resource identifier; and applies the generated rule to the information processing apparatus.

It should be noted that the information processing apparatus includes a secure OS that controls behaviors of the application, and the procedure on application of the generated rule to the information processing apparatus may apply the generated rule to the secure OS.

Also, the procedure on application of the generated rule to the information processing apparatus may acquire an attribution value of the application, and generate a rule appropriate to the application on the basis of the rule defined in advance in correspondence to the resource identifier and the application attribute value.

Further, the rule generated in the procedure may be an access control rule.

Still further, there is provided an information processing program instructing an information processing apparatus to perform: an application adding procedure that, upon addition of an application to the information processing apparatus including a secure OS that retains an identifier of a resource to be accessed by an application, from the additional application storage section that stores an application and a set of identifiers of resources used by the application as a set, acquires the application to be added and a set of identifiers of resources used by the application, refers to the application identifier storage section that stores an identifier allocated to an application to allocate an application identifier to the application to be added, and transmits the set of acquired resource identifiers and the allocated application identifier; and an access control attribute generating procedure that, from the access control rule storage section that stores a resource identifier and an access control rule for an application to use a resource corresponding to the resource identifier as a set, acquires access control rules corresponding to the set of the resource identifiers transmitted in the application adding procedure, generates, on the basis of the acquired access control rules, an access control attribute for the application allocated with the application identifier, and applies the generated access control attribute to the secure OS.

Also, there is provided an information processing program instructing an information processing apparatus to perform: an application adding procedure that, upon addition of an application to the information processing apparatus including a secure OS that retains identifiers of resources to be accessed by an application, acquires a set of the application to be added and identifiers of resources used by the application from the additional application storage section that stores a set of an application and the identifiers of the resources used by the application, refers to the application identifier storage section that stores an identifier allocated to the application to allocate the application identifier to the application to be added, and transmits the acquired resource identifiers and the allocated application identifier; an access control attribute generating procedure that acquires access control rules corresponding to the resource identifiers transmitted in the application adding procedure from the access control rule storage section that stores resource identifiers and access control rules for the application to use the resource corresponding to the resource identifiers as a set, generates an access control attribute for the application allocated with the application identifier on the basis of the acquired access control rules, applies the generated access control attribute to the secure OS, and stores the set of resource identifiers and application identifier transmitted in the application adding procedure in the application data storage section as application data; an access control rule updating procedure that, acquires an access control rule corresponding to an identifier of the resource from the update access control rule storage section that stores a resource identifier and an access control rule as a set, upon update of the access control rule of the resource, changes an access control rule stored in the access control rule storage section along with the identifier of the resource for which the access control rule is updated to the access control rule acquired from the update access control rule storage section, and transmits the identifier of the resource for which the access control rule is updated; and an access control attribute regenerating procedure that acquires the application data including the resource identifier transmitted in the access control rule updating procedure from the application data storage section, acquires the access control rules corresponding to the set of resource identifiers included in the acquired application data from the access control rule storage section, generates an access control attribute for the application identified by the application identifier included in the acquired application data on the basis of the acquired access control rules, and applies the generated access control attribute to the secure OS.

In addition, the information processing apparatus may further be instructed to perform a resource adding procedure that receives an identifier of the resource from the secure OS upon addition of the resource to the secure OS, acquires an access control rule corresponding to the received resource identifier from the additional resource storage section that stores an identifier of a resource, which can be added to the secure OS, and an access control rule for the resource as a set, and stores the received resource identifier and the acquired access control rule in the access control rule storage section as a set.

Further, preferably, the information processing apparatus is instructed to perform a resource limit determination procedure that receives the set of resource identifiers transmitted in the application adding procedure and an application attribute value; acquires a set of resource identifiers corresponding to the application attribute value from the resource restriction data storage section that stores an application attribute value and identifiers of resources available to the application having the application attribute value; when the resource identifiers transmitted in the application adding procedure are included in the resource identifiers acquired from the resource restriction data storage section, transmits a match signal, and when the resource identifiers transmitted in the application adding procedure are not included in the resource identifiers acquired from the resource restriction data storage section, transmits a mismatch signal, and the application adding procedure includes: a procedure that acquires an attribution value of the application to be added from the additional application storage section that stores the attribute value of the application along with the application and the identifiers of resources, before the resource limit determination procedure, and transmits the resource identifiers and the application attribute value acquired from the additional application storage section to the resource limit determination procedure; and a procedure that after the resource limit determination procedure, when the mismatch signal is received, application adding processing is terminated, and when the match signal is received, refers to the application identifier storage section to allocate an application identifier to the application to be added, and transmits the set of acquired resource identifiers and the allocated application identifier to the access control attribute generating section.

Further, the information processing apparatus may be instructed to perform a resource adding procedure that receives an identifier of the resource from the secure OS upon addition of a resource to the secure OS, acquires an access control rule corresponding to the received resource identifier from the additional resource storage section that stores an identifier of a resource, which can be added to the secure OS, and an access control rule for the resource as a set, stores the received resource identifier and the acquired access control rule in the access control rule storage section as a set, acquires the application attribute values corresponding to the received resource identifiers from the additional resource restriction data storage section that stores resource identifiers, and the application attribute values of applications allowed to use a resource corresponding to the resource identifier as a set, and adds the received resource identifier to the resource identifier stored in the resource restriction data storage section along with the set of application attribute values as the set.

The access control rule may be intended for a device.

The access control rule may be intended for an object.

The access control rule may be a resource usage limit rule for a device.

The access control rule may be a resource usage limit rule for an object.

The application attribute value may be one indicating a creator of an application.

The application attribute value is preferably one indicating a security level of an application.

As above, the present invention has been described referring to the exemplary embodiments; however, the present invention is not limited to any of the above-described exemplary embodiments. Various modifications one skilled in the art can be applicable may be made to a configuration and details of the present invention within the scope of the present invention.

1. An information processing system comprising:
a processing section configured to acquire identifiers of resources of the said information processing equipment to be used by an application, when said application is added to the information processing equipment, generate a rule suitable for said application based on a rule defined in advance in correspondence to said resource identifiers, and apply the generated rule to said information processing apparatus.

2. The information processing system according to claim 1, wherein said information processing equipment comprises a secure OS which controls behaviors of said application,
said processing section applies the generated rule to said secure OS.

3. The information processing system according to claim 1, wherein said processing section acquires an attribute value of said application, and generates the rule suitable for said application based on said application attribute value and the rule defined in advance in correspondence to said resource identifier.

4. The information processing system according to claim 1, wherein the rule generated by said processing section is an access control rule.

5. An information processing system comprising:
an additional application storage section configured to store a set of an application and identifiers of resources used by said application;
a secure OS configured to hold the identifiers of the resources to be accessed by said application;
an access control rule storage section configured to store said resource identifiers and an access control rule for the application to use said resource corresponding to the resource identifier as a set;
an application identifier storage section configured to store an identifier to be allocated to said application;
an application adding section configured acquire a set of said application to be added and the identifier of the resource used by said application from said additional application storage section, when adding said application to said information processing apparatus provided with said secure OS, refer said application identifier storage section to allocate the application identifier to said application to be added, and send out a set of the acquired resource identifiers and the allocated application identifier; and
an access control attribute generating section configured to acquire the access control rules corresponding to the resource identifiers received from said application adding section from said access control rule storage section, generate an access control attribute to said application allocated with said application identifier based on the acquired access control rule, and apply the generated access control attribute to said secure OS.

6. An information processing system comprising:
an additional application storage section configured to store a set of an application and identifiers of resources used by said application;
an update access control rule storage section configured to store the identifier of the resource for which an access control rule is planned to update and the access control rule as a set;
a secure OS configured to hold the identifiers of the resources to be accessed by said application;
an access control rule storage section configured to store said resource identifier and the access control rule for the application to use said resource corresponding to the resource identifier as a set;
an application identifier storage section configured to store an identifier to be allocated to said application;
an application data storage section configured to store a set of an application identifier and the identifiers of the resources used by said application corresponding to the application identifier as application data;
an application adding section configured acquire a set of said application to be added and the identifier of the resource used by said application from said additional application storage section, when adding said application to said information processing apparatus provided with said secure OS, refer said application identifier storage section to allocate the application identifier to said application to be added, and send out a set of the acquired resource identifiers and the allocated application identifier;
an access control attribute generating section configured to acquire the access control rules corresponding to the resource identifiers received from said application adding section from said access control rule storage section, generate an access control attribute to said application allocated with said application identifier based on the acquired access control rule, and apply the generated access control attribute to said secure OS, store the resource identifiers received from said application adding section and the application identifier in said application data storage section as application data;
an access control rule updating section configured to acquire the access control rule corresponding to the identifier of this resource from said update access control rule storage section, when updating the access control rule of the resource, changes the identifier of the resource which updates said access control rule and the access control rule which is stored in said access control rule storage section as a set together with the access control rule acquired from said update access control rule storage section, and send out the identifier of the resource which updates said access control rule; and
an access control attribute regenerating section configured to acquire the application data which contains the resource identifier received from the access control rule updating section, from said application information storage section, acquire the access control rule corresponding to the resource identifier contained in the acquired application data from said access control rule storage section, set an access control attribute to the application specified based on the application identifier which is contained in the application data acquired based on the acquired access control rule, and apply the generated access control attribute to said secure OS.

7. The information processing system according to claim 5, further comprising:
an additional resource storage section configured to store the identifier of the resource which it is possible to add to said secure OS and an access control rule to this resource as a set; and
a resource adding section configured to receive the identifier of the resource from said secure OS when a resource is added to said secure OS, acquire the access control rule corresponding to the received resource identifier from said addition resource storage section, and generate the received resource identifier and the acquired access control rule and generate store them in said access control rule storage section.

8. The information processing system according to claim 5, further comprising:
a resource restriction data storage section configured to store an application attribute value and the identifier of the resource to which the application with the application attribute value is available; and
a resource restriction determining section configured to receive a set of the application attribute value of the resource identifier from said application adding section, acquire the set of the resource identifier corresponding to the application attribute value from said resource restriction data storage section, transmit a match signal to said application adding section when the resource identifier received from said application adding section is contained in the resource identifier acquired from said resource restriction data storage section, and transmit a mismatch signal to said application adding section when the resource identifier received from said application adding section is not contained in the resource identifier acquired from said resource restriction data storage section,
wherein said additional application storage section stores the attribute value of the application corresponding to said application identifier,
said application adding section further comprises a section configured to acquire the attribute value of the application to be added from said additional application storage section, transmit the resource identifier and the application attribute value acquired from said additional application storage section to said resource restriction determining section, terminate an addition process of said application when the mismatch signal is received from said resource restriction determining section, refer to said application identifier storage section to allocate the application identifier to said application to be added when the match signal is received, and transmit a set of the acquired resource identifier and the allocated application identifier to said access control attribute generating section.

9. The information processing system according to claim 8, further comprising:
an additional resource storage section configured to store the identifier of the resource which it is possible to add to said secure OS and an access control rule to this resource as a set;
an addition resource restriction data storage section configured to store a set of the resource identifier and the application attribute value of said application where the use of the resource corresponding to the resource identifier is permitted; and
a resource adding section configured to receive the identifier of the resource from said secure OS when the resource is added to said secure OS, acquire the access control rule corresponding to the received resource identifier from said addition resource storage section, store a set of the received resource identifier and the acquired access control rule in said access control rule storage section, acquire the set of the application attribute value corresponding to the received resource identifier from said addition resource restriction data storage section, and add the received resource identifier and the resource identifier stored as a set with said application attribute value and the resource identifier to said resource restriction data storage section.

10. The information processing system according to claim 5, wherein said access control rule is for a device.

11. The information processing system according to claim 5, wherein said access control rule is for an object.

12. The information processing system according to claim 5, wherein said access control rule is a resource consumption volume restriction rule to the device.

13. The information processing system according to claim 5, wherein said access control rule is a resource consumption volume restriction rule to the object.

14. The information processing system according to claim 3, wherein said application attribute value indicates a creator of the application.

15. The information processing system according to claim 3, wherein said application attribute value indicates a security level of the application.

16. An information processing method including a procedure comprising:
when an application is added to the information processing apparatus, acquiring an identifier of a resource of said information processing apparatus used by said application, generating a rule suitable for said application based on the rule defined in advance in correspondence to the resource identifier, and applying the generated rule to said information processing apparatus.

17. The information processing method according to claim 16, wherein said information processing apparatus comprises a secure OS configured to control behavior of said application,
wherein the procedure of applying the generated rule to said information processing apparatus comprises applying the generated rule to said secure OS.

18. The information processing method according to claim 16, wherein the procedure of applying the generated rule to said information processing apparatus comprises:
a procedure of acquiring the attribute value of said application, and generating the rule suitable for said application based on the application attribute value and the rule defined in advance in correspondence to the resource identifier.

19. The information processing method according to claim 16, wherein the rule generated in said procedure is an access control rule.

20. An information processing method comprising:
an application adding procedure of acquiring a set of an application to be added and identifiers of resources used by said application from an additional application storage section which stores the set of said application and the identifiers of the resources used by said application, when said application is added to an information processing apparatus which comprises a secure OS which holds identifiers of resources to be accessed by said application, referring to the application identifier storage section which stores the identifier to allocated to said application to allocate an application identifier to said application to be added, and sending out the set of the acquired resource identifiers and the allocated application identifier; and
an access control attribute generating procedure of acquiring the access control rules corresponding to the resource identifiers sent out in said application adding procedure from an access control rule storage section which stores the resource identifiers and the access control rules for said application to use the resources corresponding to the resource identifiers, generating an access control attribute to said application allocated with said application identifier based on the acquired access control rule, and applying the generated access control attribute to said secure OS.

21. An information processing method comprising:
an application adding procedure of acquiring a set of an application to be added and identifiers of resources used by said application from an additional application storage section which stores the set of said application and the identifiers of the resources used by said application, when said application is added to an information processing apparatus which comprises a secure OS which holds identifiers of resources to be accessed by said application, referring to the application identifier storage section which stores the identifier to allocated to said application to allocate an application identifier to said application to be added, and sending out the set of the acquired resource identifiers and the allocated application identifier;
an access control attribute generating procedure of acquiring the access control rules corresponding to the resource identifiers sent out in said application adding procedure from an access control rule storage section which stores the resource identifiers and the access control rules for said application to use the resources corresponding to the resource identifiers, generating an access control attribute to said application allocated with said application identifier based on the acquired access control rule, applying the generated access control attribute to said secure OS, and storing the application identifier and the resource identifiers sent out in said application adding procedure in an application data storage section as application data,
an access control rule updating procedure of acquiring the access control rules corresponding to the identifiers of the resources from the update access control rule storage section which stores sets of the resource identifiers and the access control rules when updating the access control rules of the resources, changing the access control rules stored in said access control rule storage section along with the identifiers of the resources which updates the access control rules, into the access control rules acquired from said update access control rule storage section, and sending out the identifiers of the resources which update the access control rules; and
an access control attribute regenerating procedure of acquiring the application data which contains the resource identifiers sent out in said access control rule updating procedure, from said application data storage section, acquiring the access control rules corresponding to the resource identifiers which is contained in the acquired application data, from said access control rule storage section, generating the access control attribute to the application specified based on the application identifier which is contained in the acquired application data based on the acquired access control rule, and applying the generated access control attribute to said secure OS.

22. The information processing method according to claim 20, further comprising:
a resource adding procedure of receiving an identifier of a resource from said secure OS when the resource is added to said secure OS, acquiring the access control rule corresponding to the received resource identifier from an additional resource storage section which stores the identifier of the resource possible to be added to said secure OS and an access control rule to the resource, and storing the received resource identifier and the acquired access control rule in said access control rule storage section as a set.

23. The information processing method according to claim 20, further comprising:
a resource restriction determining procedure of receiving the application attribute value and the resource identifiers sent out in said application adding procedure, acquiring the resource identifiers corresponding to the application attribute value from the resource restriction data storage section which stores a set of the application attribute value and the identifiers of the resources available to the application with the application attribute value, sending out a match signal when the resource identifier sent out in said application adding procedure is contained in the resource identifier acquired from said resource restriction data storage section, and sending out a mismatch signal when the resource identifier is not contained in the resource identifier acquired from said resource restriction data storage section,
wherein said application addition procedure comprises:
a procedure of acquiring the attribute value of the application to be added from said additional application storage section which stores the application attribute value as well as the identifiers of the resources and the application before said resource restriction determining procedure, and transmitting the resource identifiers and the application attribute value acquired from said additional application storage section to said resource restriction determining procedure; and
a procedure of, after said resource restriction determining procedure, terminating the application adding process in a case of receiving the mismatch signal, and referring to said application identifier storage section to allocate the application identifier to the application to be added in a case of receiving the match signal, transmitting the acquired resource identifiers and the allocated application identifier to said access control attribute generating section.

24. The information processing method according to claim 23, further comprising:
a resource adding procedure of receiving an identifier of a resource from said secure OS when the resource is added to said secure OS, acquiring the access control rule corresponding to the received resource identifier from an additional resource storage section which stores the identifier of the resource possible to be added to said secure OS and an access control rule to the resource, storing the received resource identifier and the acquired access control rule in said access control rule storage section as a set, acquiring the application attribute values corresponding to the received resource identifiers from the addition resource restriction data storage section which stores the resource identifiers and the application attribute values of the application which is permitting to use the resource corresponding to this resource identifier, and adding the received resource identifier to the resource identifiers stored in said resource restriction data storage section as a set together with said application attribute values.

25. The information processing method according to claim 19, wherein said access control rule is for a device.

26. The information processing method according to claim 19, wherein and said access control rule is for an object.

27. The information processing method according to claim 19, wherein said access control rule is a resource use restriction rule to a device.

28. The information processing method according to claim 19, wherein said access control rule is a resource use restriction rule to an object.

29. The information processing method according to claim 18, wherein said application attribute value indicates a creator of the application.

30. The information processing method according to claim 18, wherein said application attribute value indicates a security level of the application.

31. The information processing system according to claim 6, further comprising:
an additional resource storage section configured to store the identifier of the resource which it is possible to add to said secure OS and an access control rule to this resource as a set; and
a resource adding section configured to receive the identifier of the resource from said secure OS when a resource is added to said secure OS, acquire the access control rule corresponding to the received resource identifier from said addition resource storage section, and generate the received resource identifier and the acquired access control rule and generate store them in said access control rule storage section.

32. The information processing system according to claim 6, further comprising:
a resource restriction data storage section configured to store an application attribute value and the identifier of the resource to which the application with the application attribute value is available; and
a resource restriction determining section configured to receive a set of the application attribute value of the resource identifier from said application adding section, acquire the set of the resource identifier corresponding to the application attribute value from said resource restriction data storage section, transmit a match signal to said application adding section when the resource identifier received from said application adding section is contained in the resource identifier acquired from said resource restriction data storage section, and transmit a mismatch signal to said application adding section when the resource identifier received from said application adding section is not contained in the resource identifier acquired from said resource restriction data storage section,
wherein said additional application storage section stores the attribute value of the application corresponding to said application identifier,
said application adding section further comprises a section configured to acquire the attribute value of the application to be added from said additional application storage section, transmit the resource identifier and the application attribute value acquired from said additional application storage section to said resource restriction determining section, terminate an addition process of said application when the mismatch signal is received from said resource restriction determining section, refer to said application identifier storage section to allocate the application identifier to said application to be added when the match signal is received, and transmit a set of the acquired resource identifier and the allocated application identifier to said access control attribute generating section.
